(19) United States
(12) Patent Application Publication
(10) Pub. No.: US 2013/0182777 A1
(43) Pub. Date: Jul. 18, 2013

(54) IMAGE PROCESSING APPARATUS AND METHOD

(71) Applicant: Sony Corporation, Tokyo (JP)

(72) Inventor: Kazushi SATO, Kanagawa (JP)

(73) Assignee: SONY CORPORATION, Tokyo (JP)

(21) Appl. No.: 13/684,924

(22) Filed: Nov. 26, 2012

(30) Foreign Application Priority Data
Jan. 18, 2012 (JP) 2012008461

(51) Int. Cl. H04N 7/26

(52) U.S. Cl. CPC H04N 7/26335
USPC 375/240.25

(57) ABSTRACT

An image processing apparatus includes a receiver that receives an encoded stream and a field coding flag indicating field coding or not that is transmitted for each sequence, and a decoder that generates an image by decoding an encoded stream received by the receiver according to the field coding flag received by the receiver.

### BACKGROUND

The present disclosure relates to an image processing apparatus and method, and more particularly, to an image processing apparatus and method configured to enable efficient encoding or decoding in the case where the input is an interlaced signal.

Recently, there has been a proliferation of apparatus that digitally handle image information, and when so doing, compress images for the purpose of efficient information transfer and storage. Such apparatus compress images by implementing coding formats that utilize redundancies specific to image information and compress information by orthogonal transform such as the discrete cosine transform and by motion compensation. Such coding formats include those of the Moving Picture Experts Group (MPEG), for example.

Particularly, MPEG-2 (ISO/IEC 13818-2) is defined as a general-purpose image coding format, and is a standard that encompasses both interlaced scan images and progressive scan images, as well as standard definition images and high definition images. MPEG-2, for example, is currently widely used in a broad range of applications for both professional use and consumer use. By using the MPEG-2 compression format, a bit rate from 4 to 8 Mbps is allocated if given a standard definition interlaced scan image having 720×4 80 pixels, for example. Also, by using the MPEG-2 compression format, a bit rate from 18 to 22 Mbps is allocated if given a high definition interlaced scan image having 1920×1088 pixels, for example. Thus, it is possible to realize a high compression rate and favorable image quality.

Although MPEG-2 has primarily targeted high image quality coding suitable for broadcasting, it is not compatible with coding formats having a bit rate lower than that, of MPEG-1, or in other words a high compression rate. Due to the proliferation of mobile devices, it is thought that the demand for such coding formats will increase in the future, and in response the MPEG-4 coding format has been standardized. MPEG-4 was designated an international standard for image coding in December 1998 as ISO/IEC 14496-2.

As part of the standardization schedule, H.264 and MPEG-4 Part 10 (Advanced Video Coding, hereinafter abbreviated to AVC) was internationally standardized in March 2003.

Additionally, as an extension of the AVC format, standardization of the FRExt (Fidelity Range Extension) was completed in February 2005. FRExt includes coding tools for business use, such as RGB, 4:2:2, and 4:4:4, as well as the 8×8 DCT ana quantization matrices defined in MPEG-2. As a result, the AVC format can be used, for image coding able to favorably express even the film noise included in movies, which has led to its use in a wide range of applications such as Blu-Ray Discs (trademark).

However, demand is growing for coding at even higher compression rates, such as for compressing images having approximately 4000×2000 pixels, four times that of high definition images, or for delivering high, definition images in an environment of limited transmission capacity such as the Internet. For this reason, there is ongoing investigation related to improving coding efficiency by the Video Coding Experts Group (VCEG) of the ITU-T.

Meanwhile, there have been concerns that a macroblock size set to 16×16 pixels may not be optimal for large image sizes such as Ultra High Definition (UHD) (4000×2000 pixels) which will be the targets of next-generation coding formats.

Consequently, standardization of a coding format called High Efficiency Video Coding (HEVC) is currently progressing under work by the Joint Collaboration Team-Video Coding (JCTVC), a joint standards group between the ITU-T and the ISO/IEC, with the aim of further improving the coding efficiency over AVC. (For example, see Joel Jung, Guillaume Laroche, “Competition-Based Scheme for Motion Vector Selection and Coding”, VCEG-AC06, ITU—Telecommunications Standardization Sector STUDY GROUP 16 Question 6 Video Coding Experts Group (VCEG) 29th Meeting: Klagenfurt, Austria, 17-18 Jul. 2006.)

With the HEVC coding format, a coding unit (CU) is defined as a unit of processing similar to a macroblock in the AVC format. CUs are not fixed at a size of 16×16 pixels as in the AVC format, but instead are specified in the image compression information in respective sequences. Additionally, the sizes of the largest CU (Largest Coding Unit or LCU) and the smallest CU (Smallest. Coding Unit or SCU) are also stipulated in respective sequences.

CUs are split into prediction units (PUs), which are areas (i.e., partial areas of an image for a single picture) used as units of processing during intra or inter prediction, and are furthermore split into transform units (TUs), which are areas (i.e., partial areas of an image for a single picture) used as units of processing during orthogonal transform.

With inter PUs, it is possible to split a single CU of size 2N×2N into 2N×2N, 2N×N, N×2N, or N×N sizes.

Meanwhile, with the AVC format, it is possible to select between frame coding and field coding in units of pictures or macroblock pairs in the case where the input image is an interlaced signal. In an interlaced signal, frames and macroblocks are made up of alternating fields with differing parity (top or bottom), called top fields and bottom fields.

Field coding is a method of individually coding top fields and bottom fields, while frame coding is a method of coding without dividing frames into a top field and a bottom field.

Additionally, in the case of field coding with the AVC format, the vertical component of the motion vector for the chroma signal is shifted when the field being processing differs from, the reference field.

### SUMMARY

It is anticipated that the above-described functions related to interlaced signals will also be applied to HEVC. However, in the case where the input is an interlaced signal, processing may become more complicated, if the process of selecting whether to conduct field coding or frame coding in units of macroblock pairs is applied to CUs, the units of processing defined in HEVC.

In light of such circumstances, it is desirable to enable efficient encoding or decoding in the case where the input is an interlaced signal.

An image processing apparatus according to an embodiment of the present disclosure includes a receiver that receives an encoded stream and a field coding flag indicating field coding or not that is transmitted for each sequence, and a decoder that generates an image by decoding an encoded stream received by the receiver according to the field coding flag received by the receiver.

It may also be configured such that the receiver receives a parity flag indicating the parity of individual fields and transmitted for each picture, and in the case where the field coding flag received by the receiver indicates field coding, the decoder generates an image by decoding an encoded stream received, by the receiver according to the parity flag received by the receiver.

The field coding flag may be set in a sequence parameter set.

The parity flag may be set in an adaptation parameter set.

It may also be configured such that the receiver receives instruction information for display as an interlaced signal, which is set and transmitted in a supplemental enhanced information message, and in the case where the field coding flag received by the receiver indicates frame coding, the decoder generates an image by decoding an encoded stream received by the receiver according to the instruction information received by the receiver, and outputs the generated, image as an interlaced signal.

An image processing method according to an embodiment of the present disclosure includes receiving an encoded, stream and a field coding flag indicating field coding or not that is transmitted for each sequence, and generating an image by decoding the received encoded stream according to the received field coding flag.

An image processing apparatus according to another embodiment of the present disclosure includes an encoder that, encodes an image according to whether or not the image is to be field coded, and generates an encoded stream, a setting unit that, sets, for each sequence, a field coding flag indicating whether or not to field code the image, and a transmitter that transmits the encoded stream generated by the encoder and the field coding flag set for each sequence by the setting unit.

It may also be configured such that the setting unit sets, for each picture, a parity flag indicating the parity of individual fields in the case where the image is to be field coded, and the transmitter transmits the parity flag set by the setting unit for each picture.

The setting unit may set the field coding flag in a sequence parameter set.

The setting unit sets the parity flag in an adaptation parameter set.

It may also be configured such that in the case where the image is to be frame cooled but displayed as an interlaced signal, the setting unit sets instruction information for display as an interlaced signal in a supplemental enhanced information message, and the transmitter transmits the supplemental enhanced information in which the instruction information has been set by the setting unit.

An image processing method according to another embodiment of the present disclosure includes encoding an image according to whether or not the image is to be field coded, and generating an encoded stream, setting, for each sequence, a field coding flag indicating whether or not to field code the image, and transmitting the generated encoded stream and the field coding flag set for each sequence.

According to an embodiment of the present disclosure, an encoded stream and a field coding flag indicating field coding or not that is transmitted for each, sequence is received, and an image is generated by decoding the received encoded stream according to the received field coding flag.

According to another embodiment of the present disclosure, an image is encoded according to whether or not the image is to be field coded, and an encoded stream is generated. A field coding flag indicating whether or not to field code the image is then set for each, sequence, and the generated encoded stream and the field coding flag set for each sequence are transmitted.

Note that the image processing apparatus discussed, above may be independent apparatus, or internal blocks constituting a single image encoding apparatus or image decoding apparatus.

According to an embodiment in accordance with the present disclosure, images may be decoded. Particularly, decoding efficiency may be improved in the case where the input is an interlaced signal.

According to another embodiment in accordance with the present disclosure, images may be encoded. Particularly, encoding efficiency may be improved in the case where the input is an interlaced signal.

### BRIEF DESCRIPTION OF THE DRAWINGS

FIG. 1 is a block diagram, illustrating an exemplary primary configuration of an image encoding apparatus;

FIG. 2 illustrates exemplary structures of coding units;

FIG. 3 illustrates an example of encoding an interlaced signal in units of pictures;

FIG. 4 illustrates an example of encoding an interlaced signal in units of macroblock pairs;

FIG. 5 illustrates syntax examples for a sequence parameter set in the AVC format;

FIG. 6 illustrates syntax examples for a sequence parameter set in the AVC format;

FIG. 7 illustrates syntax examples for a slice header in the AVC format;

FIG. 8 illustrates syntax examples for a slice header in the AVC format;

FIG. 9 illustrates syntax examples for slice data in the AVC format;

FIG. 10 illustrates an example of motion vector shifting;

FIG. 11 illustrates an example of motion vector shifting;

FIG. 12 illustrates syntax examples according to an embodiment of the present technology;

FIG. 13 illustrates syntax examples according to an embodiment of the present technology;

FIG. 14 is a block diagram illustrating an exemplary primary configuration of an interlace parameter encoder and lossless encoder;

FIG. 15 is a flowchart illustrating an exemplary flow of an encoding process;

FIG. 16 is a flowchart illustrating an exemplary flow of an encoding process in the VCL;

FIG. 17 is a flowchart illustrating an exemplary flow of an inter prediction process;

FIG. 18 is a block diagram illustrating an exemplary primary configuration of an image decoding apparatus;

FIG. 19 is a block diagram illustrating an exemplary primary configuration of an interlace parameter receiver and lossless decoder;

FIG. 20 is a flowchart illustrating an exemplary flow of a decoding process;

FIG. 21 is a flowchart illustrating an exemplary flow of a decoding process in the VCL;

FIG. 22 is a block diagram, illustrating an exemplary primary configuration of a computer;

FIG. 23 is a block diagram illustrating an example of a schematic configuration of a television;

FIG. 24 is a block diagram illustrating an example of a schematic configuration of a mobile phone;

FIG. 25 is a block diagram illustrating an example of a schematic configuration of a recording and playback apparatus; and

FIG. 26 is a block diagram illustrating an example of a schematic configuration of an imaging apparatus.

### DETAILED DESCRIPTION OF EMBODIMENTS

Hereinafter, embodiments for carrying out the present disclosure (hereinafter designated embodiments) will be described. The description will proceed in the following order.

1. First embodiment (image encoding apparatus)
2. Second embodiment (image decoding apparatus)
3. Third embodiment (computer)
4. Exemplary applications

### 1. First Embodiment

### Image Encoding Apparatus

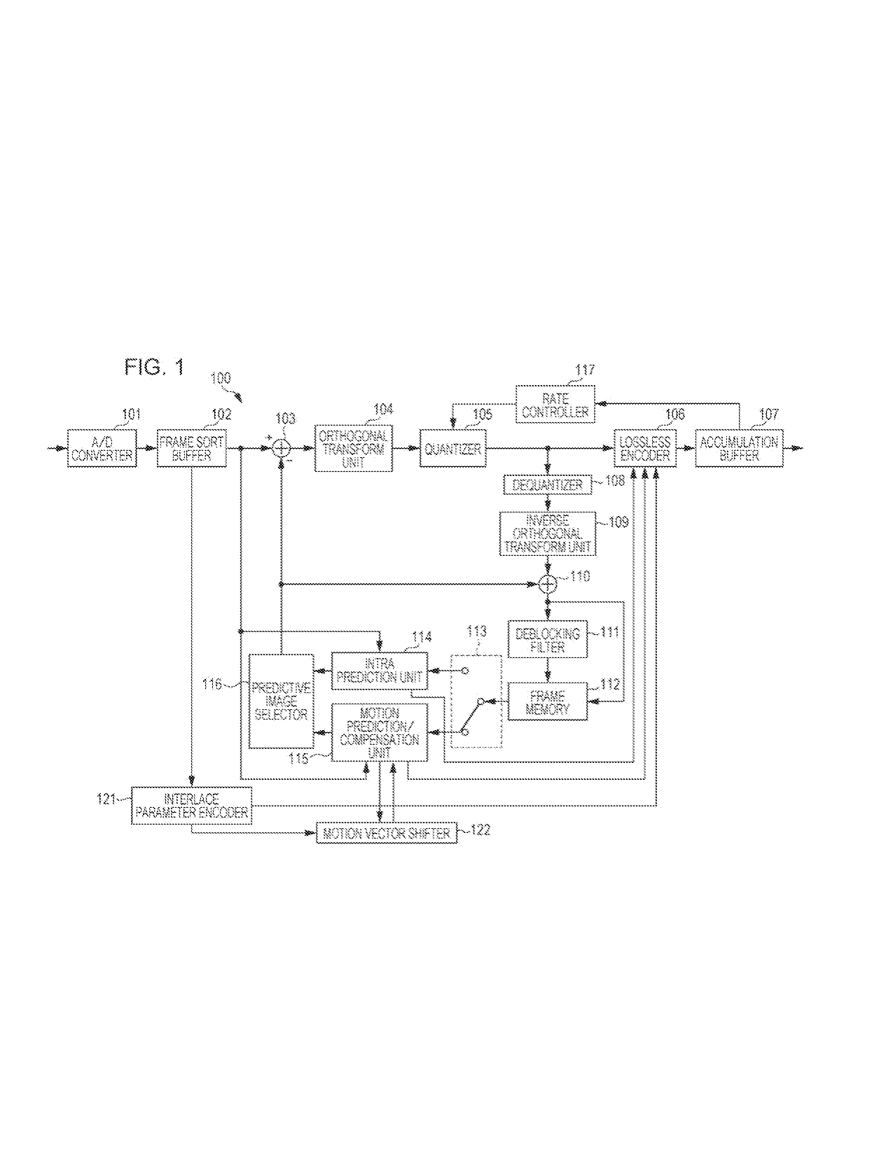

FIG. 1 is a block diagram illustrating an exemplary primary configuration of an image encoding apparatus.

The image encoding apparatus 100 illustrated in FIG. 1 encodes image data using prediction processes in a format compliant with High Efficiency Video Coding (HEVC), for example.

As illustrated in FIG. 1, the image encoding apparatus 100 includes an A/D converter 101, a frame sort buffer 102, an arithmetic unit 103, an orthogonal transform unit 104, a quantizer 105, a lossless encoder 106, an accumulation buffer 107, a dequantizer 108, and an inverse orthogonal transform unit 109. Additionally, the image encoding apparatus 100 includes an arithmetic unit 110, a deblocking filter 111, frame memory 112, a selector 113, an intra prediction unit 114, a motion prediction/compensation unit 115, a predictive image selector 116, and a rate controller 117.

The image encoding apparatus 100 additionally includes an interlace parameter encoder 121 and a motion vector shifter 122.

The A/D converter 101 A/D converts input image data, and supplies the converted image data (digital data) to the frame sort buffer 102 for storage.

Assume herein that input and output is handled by interlaced signals in the image encoding apparatus 100. With an interlaced signal, two fields constitute a single frame, with the spatially higher field being called the top field, and the spatially lower field being called the bottom field. The particular type of a given field (top or bottom) is called its parity.

Also, in the image encoding apparatus 100, it is possible to set whether to conduct field coding or frame coding in the case where the input image is an interlaced signal. In the case where the input image is an interlaced signal, field coding information indicating whether or not to conduct field coding is input into the frame sort buffer 102 via a user input unit or other means not illustrated in the drawings.

On the basis of the field coding information, the frame sort buffer 102 takes the images of frames in their stored display order and resorts them into a frame order for encoding according to groups of pictures (GOPs). The frame sort, buffer 102 then supplies the images in their resorted frame order to the arithmetic unit 103. The frame sort buffer 102 also supplies the images in their resorted frame order to the intra prediction unit 114 and the motion prediction/compensation unit 115.

In addition, the frame sort buffer 102 supplies the field coding information to the interlace parameter encoder 121. Meanwhile, in the case of field coding, the frame sort buffer 102 additionally supplies per-field parity information to the interlace parameter encoder 121.

The arithmetic unit 103 subtracts a predictive image supplied from the intra prediction unit 114 or the motion prediction/compensation unit 115 via the predictive image selector 116 from an image retrieved from the frame sort buffer 102.

For example, in the case of an inter-coded image, the arithmetic unit 103 subtracts a predictive image supplied, by the motion prediction/compensation unit 115 from an image retrieved from the frame sort buffer 102.

The orthogonal transform unit 104 applies an orthogonal transform such as the discrete cosine transform or the Karhunen-Loeve transform to error information output from the arithmetic unit 103. The orthogonal transform method herein is arbitrary. The orthogonal transform unit 104 supplies the transform coefficients to the quantizer 105.

The quantizer 105 quantizes the transform, coefficients supplied from the orthogonal transform unit 104. The quantizer 105 sets a quantization parameter on the basis of information related, to a target value for the bit rate supplied from the rate controller 117, and quantizes accordingly. The quantization method herein is arbitrary. The quantizer 105 supplies the quantized transform coefficients to the lossless encoder 106.

The lossless encoder 106 encodes the transform coefficients quantized by the quantizer 105 according to an arbitrary coding format. Since the coefficient data has been quantized under control by the rate controller 117, its bit rate equals (or approximates) the target value set by the rate controller 117.

The lossless encoder 106 acquires, from the interlace parameter encoder 121, field coding information (i.e., a flag) indicating whether or not to conduct field coding. Also, in the case of field coding, the lossless encoder 106 additionally acquires per-field parity information (i.e., flags) from the interlace parameter encoder 121. The lossless encoder 106 also acquires information indicating the intra prediction mode, etc. from the intra prediction unit 114, and acquires information indicating the inter prediction mode and differential motion vector information, etc. from the motion prediction/compensation unit 115.

The lossless encoder 106 encodes this various information according to an arbitrary coding format, and sets (multiplexes) the encoded data (also referred to as an encoded stream) as part of the header information. The lossless encoder 106 supplies the encoded data obtained by encoding to the accumulation buffer 107 for buffering.

The coding format of the lossless encoder 106 may be variable-length coding or arithmetic coding, for example. Examples of variable-length coding include context-adaptive variable-length coding (CAVLC) stipulated in the AVC format. Examples of arithmetic coding include context-adaptive binary arithmetic coding (CAE-AC), for example.

The accumulation buffer 107 temporarily holds encoded data supplied from the lossless encoder 106. The accumulation buffer 107 outputs the encoded data being stored at given timings to a downstream recording apparatus (recording medium) or transmission channel, for example. In other words, the accumulation buffer 107 is also a transmitter that transmits encoded data.

Additionally, the transform coefficients quantized by the quantizer 105 are also supplied to the dequantizer 108. The dequantizer 108 dequantizes the quantized data according to a method corresponding to the quantization by the quantizer 105. The dequantization method may be any method insofar as it is a method that corresponds to the quantization processing by the quantizer 105. The dequantizer 108 supplies the obtained transform coefficients to the inverse orthogonal transform unit 109.

The inverse orthogonal transform unit 109 subjects the transform coefficients supplied from the dequantizer 108 to an inverse orthogonal transform corresponding to the orthogonal transform processing by the orthogonal transform unit 104. The inverse orthogonal transform method may be any method insofar as it is a method that corresponds to the orthogonal transform processing by the orthogonal transform unit 104. The inverse orthogonally transformed output (i.e., the restored error information) is supplied to the arithmetic unit 110.

The arithmetic unit 110 adds the restored error information (i.e., the inverse orthogonal transform results supplied from the inverse orthogonal transform unit 109) to a predictive image supplied from, the intra prediction unit 114 or the motion prediction/compensation unit 115 via the predictive image selector 116, and obtains a locally decoded image. This decoded image is supplied to the deblocking filter 111 or the frame memory 112.

The deblocking filter 111 applies deblocking filtering as appropriate to the decoded image supplied from the arithmetic unit 110. For example, the deblocking filter 111 may remove blocking artifacts from a decoded image by applying deblocking filtering to the decoded image.

The deblocking filter 111 supplies the filtered result (i.e., the decoded image after the filtering) to the frame memory 112. However, as mentioned, above, a decoded image output from the arithmetic unit 110 may also be supplied to the frame memory 112, bypassing the deblocking filter 111. In other words, the filtering by the deblocking filter 111 may be omitted.

The frame memory 112 stores supplied decoded images, and at given timings, supplies the decoded images being stored to the selector 113 as reference images.

The selector 113 selects a supply destination for a reference image supplied from the frame memory 112. For example, in the case of inter prediction, the selector 113 may supply the motion prediction/compensation unit 115 with a reference image supplied from the frame memory 112.

The intra prediction unit 114 uses pixel values in a picture being processed (i.e., a reference image supplied, from the frame memory 112 via the selector 113) to conduct, intra prediction (intra-frame prediction), which generates a predictive image by basically taking prediction units (PUs) as the units of processing. The intra prediction unit 114 conducts intra prediction in multiple predefined intra prediction modes.

The intra prediction unit 114 generates predictive images in all candidate intra prediction modes, uses an input image supplied from the frame sort buffer 102 to evaluate a cost function value for each predictive image, and selects the optimal mode. Upon selecting the optimal intra prediction mode, the intra prediction unit 114 supplies the predictive image generated with the optimal mode to the predictive image selector 116.

Also, as discussed earlier, the intra prediction unit 114 supplies intra prediction information indicating the implemented intra prediction mode, etc. to the lossless encoder 106 for encoding.

The motion prediction/compensation unit 115 uses an input image supplied from the frame sort buffer 102 and a reference image supplied from the frame memory 112 via the selector 113 to conduct motion prediction (inter prediction), which basically takes PUs as the units of processing. The motion prediction/compensation unit 115 conducts motion compensation according to detected, motion vectors and generates a predictive image (inter prediction image information). The motion prediction/compensation unit 115 conducts such inter prediction in multiple predefined inter prediction modes.

The motion prediction/compensation unit 115 uses an input image supplied from the frame sort buffer 102 and motion vector information, etc. to evaluate a cost function value for each predictive image, and selects the optimal mode. Upon selecting the optimal inter prediction mode, the motion prediction/compensation unit 115 generates a predictive image in the optimal mode and supplies the predictive image thus generated to the predictive image selector 116.

In the case of field coding, motion vector information for the luma signal and information regarding reference PUs is supplied to the motion vector shifter 122 from the motion prediction/compensation unit 115. In response to being supplied with such information, motion vector shifting is conducted by the motion vector shifter 122, and shifted chroma signal motion vector information is supplied from the motion vector shifter 122. Consequently, chroma signal motion vector information that has been shifted by the motion vector shifter 122 is used in the generation of a predictive image in the case of field coding.

When decoding encoded data or the information indicating the implemented inter prediction mode, the motion prediction/compensation unit 115 supplies information related to processing in that inter prediction mode to the lossless encoder 106 for encoding.

The predictive image selector 116 selects a source from which to supply a predictive image to the arithmetic unit 103 and the arithmetic unit 110. For example, in the case of inter coding, the predictive image selector 116 selects the motion prediction/compensation unit 115 as the predictive image supply source, and supplies the arithmetic unit 103 and the arithmetic unit 110 with a predictive image supplied from the motion prediction/compensation unit 115.

The rate controller 117 controls the rate of quantization operations by the quantizer 105 on the basis of the bit rate of encoded data buffered in the accumulation buffer 107, such that overflows or underflows do not occur.

The interlace parameter encoder 121 acquires field coding information indicating whether or not to conduct field coding on each sequence from the frame sort buffer 102. The interlace parameter encoder 121 supplies the acquired field coding information to the motion vector shifter 122 at given timings. The interlace parameter encoder 121 also sets the acquired field coding information as a field coding flag, which is supplied to the lossless encoder 106 for each sequence.

In the case where the field coding information indicates that field coding is to be conducted, the interlace parameter encoder 121 acquires parity information for each field from the frame sort buffer 102. The interlace parameter encoder 121 supplies the acquired parity information to the motion vector shifter 122 at given timings. The interlace parameter encoder 121 also sets the acquired parity information as a parity flag, which is supplied to the lossless encoder 106 for each picture.

Upon acquiring the parity information for each field from the interlace parameter encoder 121, the motion vector shifter 122 acquires luma signal motion vector information from the motion prediction/compensation unit 115. Using the acquired luma signal motion vector information, the motion vector shifter 122 shifts the chroma signal motion vectors according to the per-field parity information from the interlace parameter encoder 121. At this point, information regarding reference PUs is also acquired from the motion prediction/compensation unit 115 and used for processing. The motion vector shifter 122 supplies the shifted chroma signal motion vector information to the motion prediction/compensation unit 115.

### Coding Units

Next, the coding units stipulated in the HEVC format will be described. A macroblock size set to 16×16 pixels may not be optimal for large image sizes such as Ultra High Definition (UHD) (4000×2000 pixels) which will be the targets of next-generation coding formats.

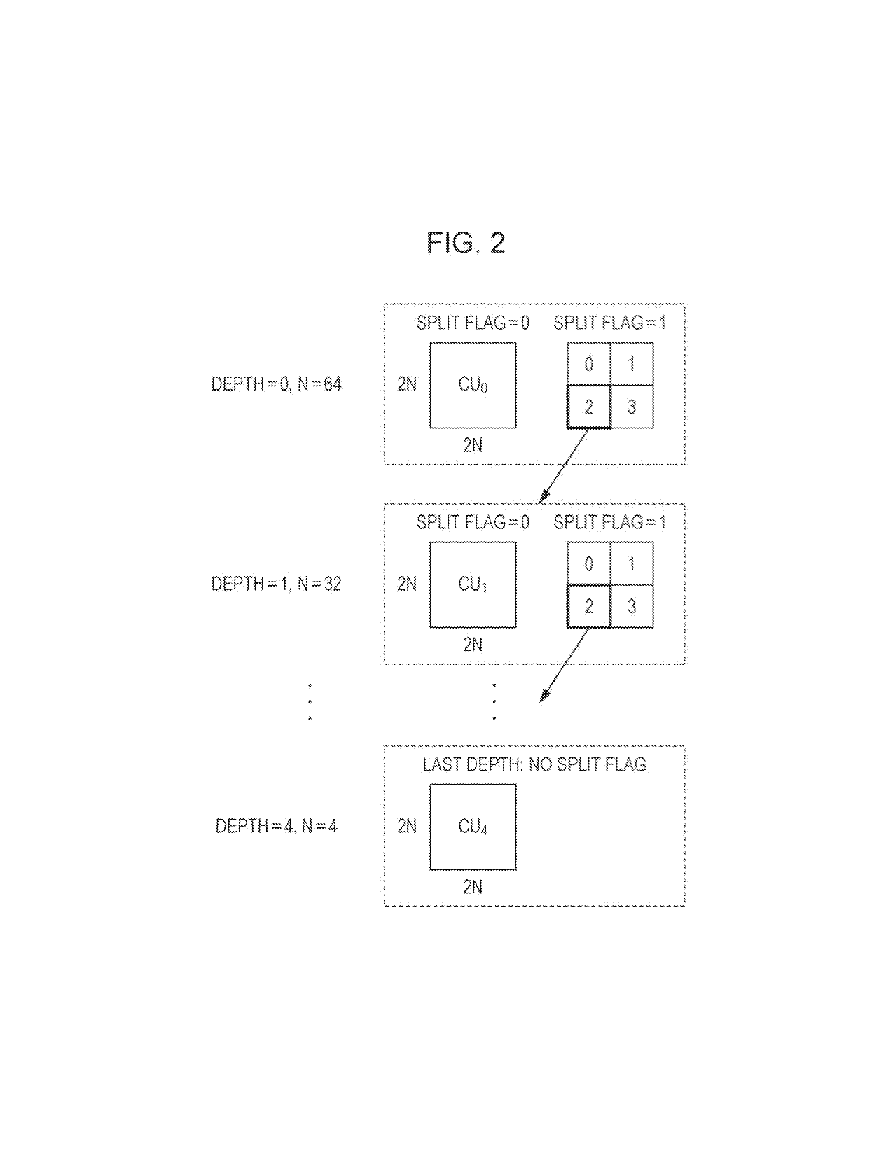

Consequently, although a layered structure of macro-blocks and sub-macroblocks is stipulated in the AVC format, coding units (CUs) are stipulated with the HEVC format, for example, as illustrated, in FIG. 2.

A CU, also called a coding tree block (CTB), is a partial area of an image for a single picture, and fulfills a similar role to a macroblock in the AVC format. Whereas a macroblock is fixed, at a size of 16×16 pixels, the size of a CU is not fixed, but rather is specified in the image compression information in respective sequences.

For example, the sizes of the largest CU (Largest Coding Unit or LCU) and the smallest CU (Smallest Coding Unit or SCU) are stipulated in the sequence parameter set (SPS) included in the output encoded data.

Within respective LCUs, subdivision into CUs of smaller size is possible by setting split_flag=1, insofar as the subdivided CUs do not fall below the SCU size. In the example illustrated in FIG. 2, the size of the LCU is 128, and the maximum layer depth is 5. When the value of split_flag is 1, a CU of size 2N×2N is split into CUs of size N×N one layer below.

Furthermore, CUs are split into prediction units (PUs), which are areas (i.e., partial areas of an image for a single picture) used as units of processing during intra or inter prediction. The PUs are then split into transform units (TUs), which are areas (i.e., partial areas of an image for a single picture) used as units of processing during orthogonal transform. At present, with the HEVC format it is possible to use 16×16 and 32×32 orthogonal transforms in addition to 4×4 and 8×8.

With inter Pus, it is possible to split a single CU of size 2N×2N into 2N×2N, 2N×N, N×2N, or N×N sizes. An inter_{—}4×4_enable_flag is defined in the sequence parameter set mentioned earlier, and by setting the value to 0 it becomes possible to forbid the use of inter CUs with a 4×4 block size.

In the case of a coding format in which CUs are defined and various processing is conducted in units of those CUs, as in the above HEVC format, it is possible to consider macroblocks in the AVC format as being equivalent to LCUs, and blocks (sub-blocks) as being equivalent to CUs. Also, it is possible to consider motion compensation blocks in the AVC format as being equivalent to PUs. However, since CUs have a layered structure, the LCU size in the uppermost layer is typically set to a larger value than that of macroblocks in the AVC format, such as 128×128 pixels, for example.

### Coding Interlaced Signals

Next, the coding of interlaced signals in the AVC format will be described. In an interlaced signal, pictures are made up of alternating fields with differing parity (top or bottom), called top fields and bottom fields. Also, with the AVC format, it is possible to select, between frame coding and field, coding in units of pictures or macroblock pairs in the case where the input image is an interlaced signal. Hereinafter, the coding of such interlaced signals will be designated frame/field coding as appropriate.

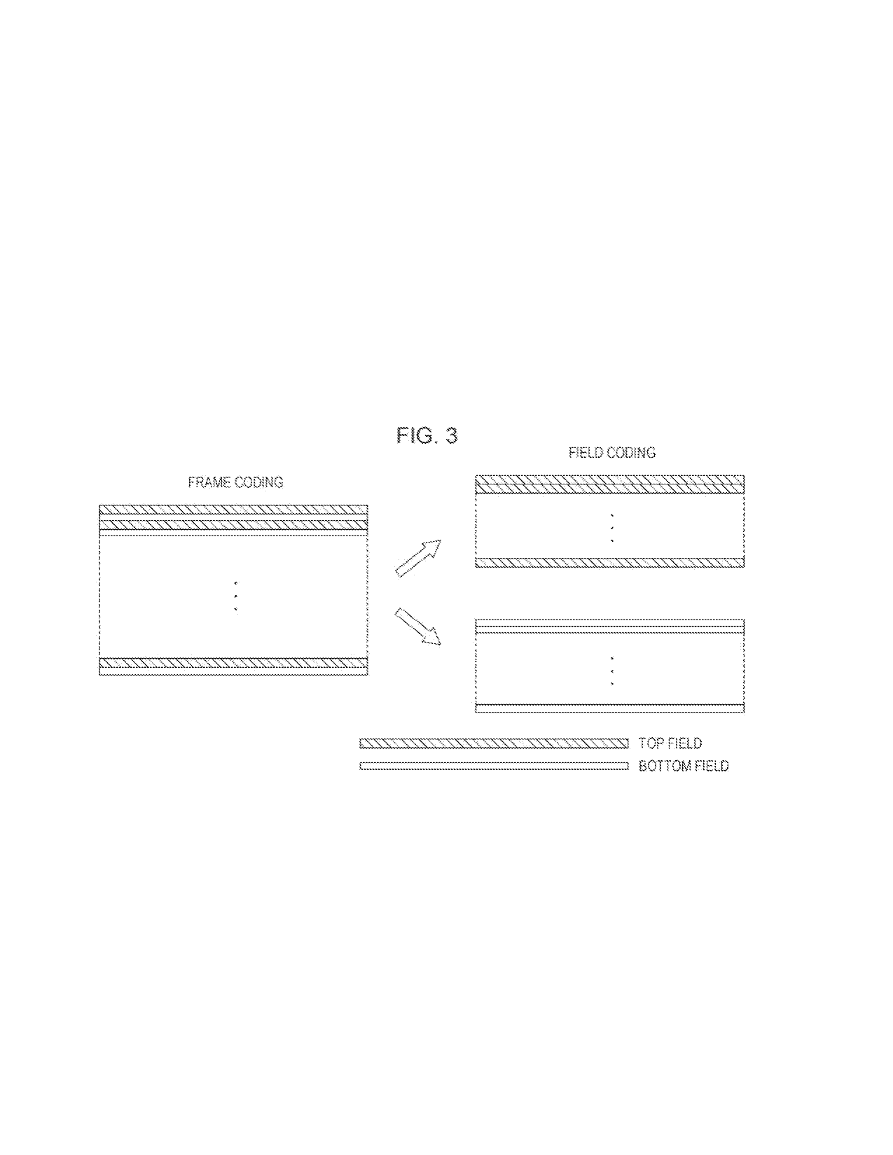

FIG. 3 illustrates an example of encoding an interlaced signal in units of pictures. The example in FIG. 3 illustrates a frame-coded picture and a field-coded picture. The shaded field represents the top field, while the unshaded field represents the bottom field.

With frame coding, a picture is encoded as-is, and contains alternating lines from, the top field and the bottom field. In contrast, with field, coding, a picture is separated into a top field and a bottom field, or in other words, is encoded with different parity values.

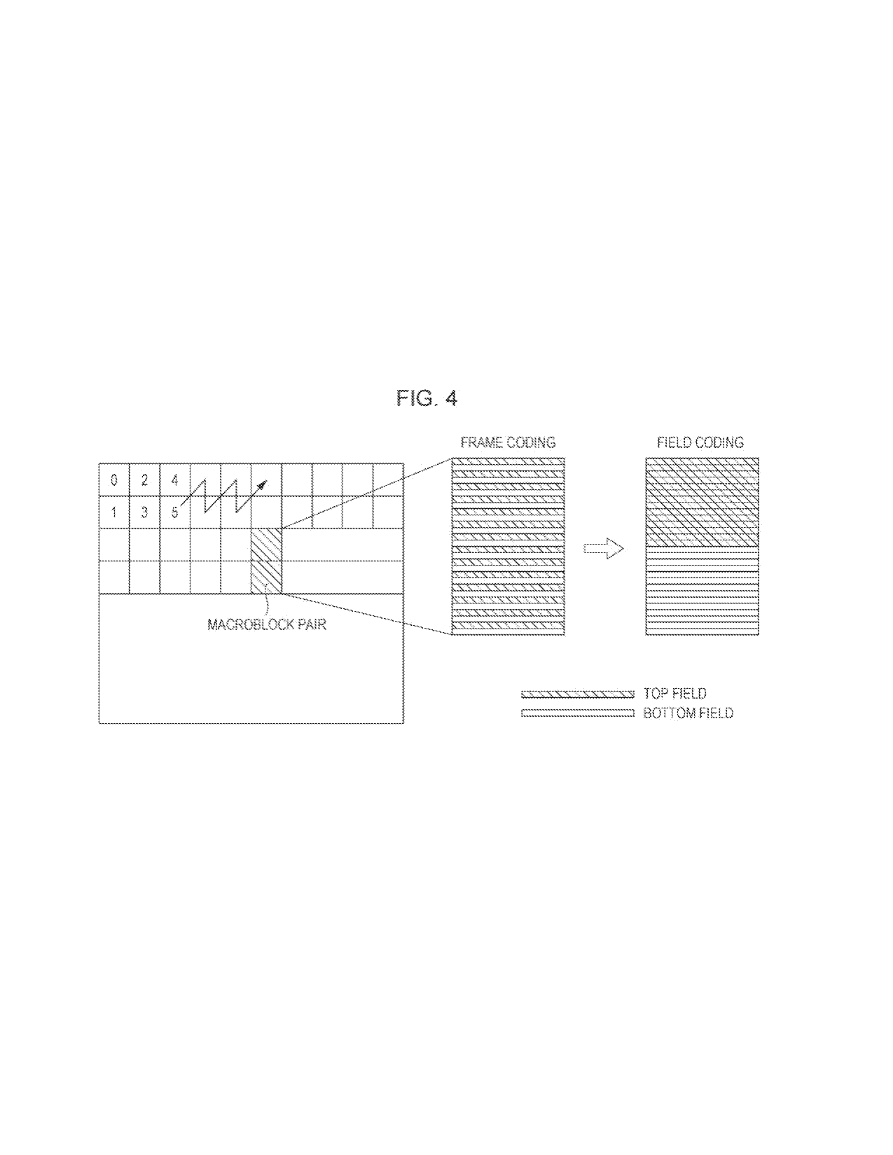

FIG. 4 illustrates an example of encoding an interlaced signal in units of macroblock pairs. In the AVC format, macroblocks made up of 16×16 pixels are ordinarily used. The respective squares outlined in FIG. 4 are taken to be individual macroblocks. Macroblocks may be set in order starting from the top-left of the image. In this example, the macroblock at the extreme top-left is taken to be the number 0 macroblock, and the adjacent macroblock below the number 0 macroblock is taken to be the number 1 macroblock. In addition, the adjacent macroblock to the right of the number 0 macroblock is taken to be the number 2 macroblock, and the adjacent macroblock to the right of the number 1 macroblock is taken to be the number 3 macroblock.

In the AVC format, it is configured such that frame coding or field coding may be adaptively selected for each macroblock pair, which includes two vertically adjacent macroblocks in the image. In this example, one macroblock pair is formed by the two macroblocks numbered 0 and 1, another macroblock pair is formed by the two macroblocks numbered 2 and 3, and so on.

The case of macroblock pairs illustrated in FIG. 4 is still similar to the case of pictures discussed earlier with FIG. 3. In other words, with frame coding, a macroblock pair is encoded as-is, and contains alternating lines from the top field and the bottom field. In contrast, with field coding, a macroblock pair is separated into a top field and a bottom field, or in other words, is encoded with different parity values.

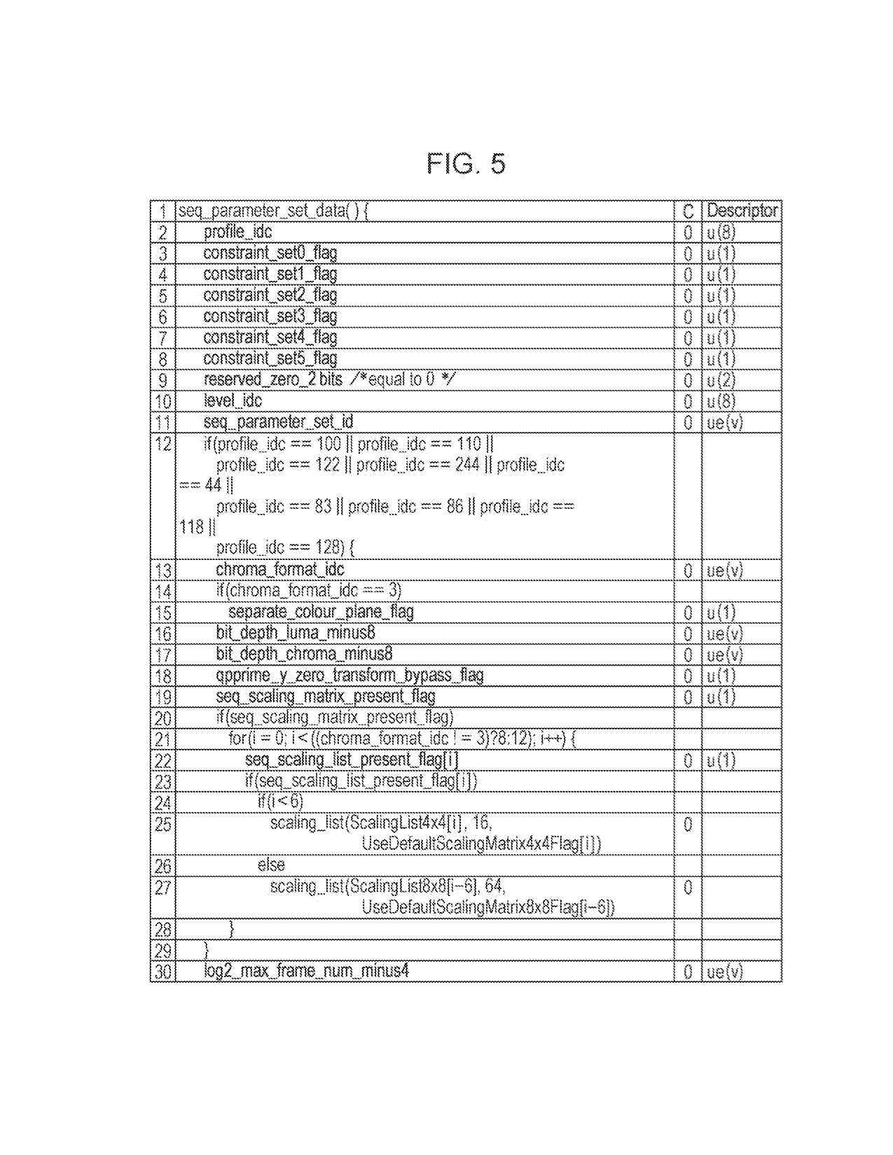

For such coding of interlaced, signals, the information illustrated in FIGS. 5 to 9 is stipulated as syntax elements in the AVC format.

### Syntax Examples in the AVC Format

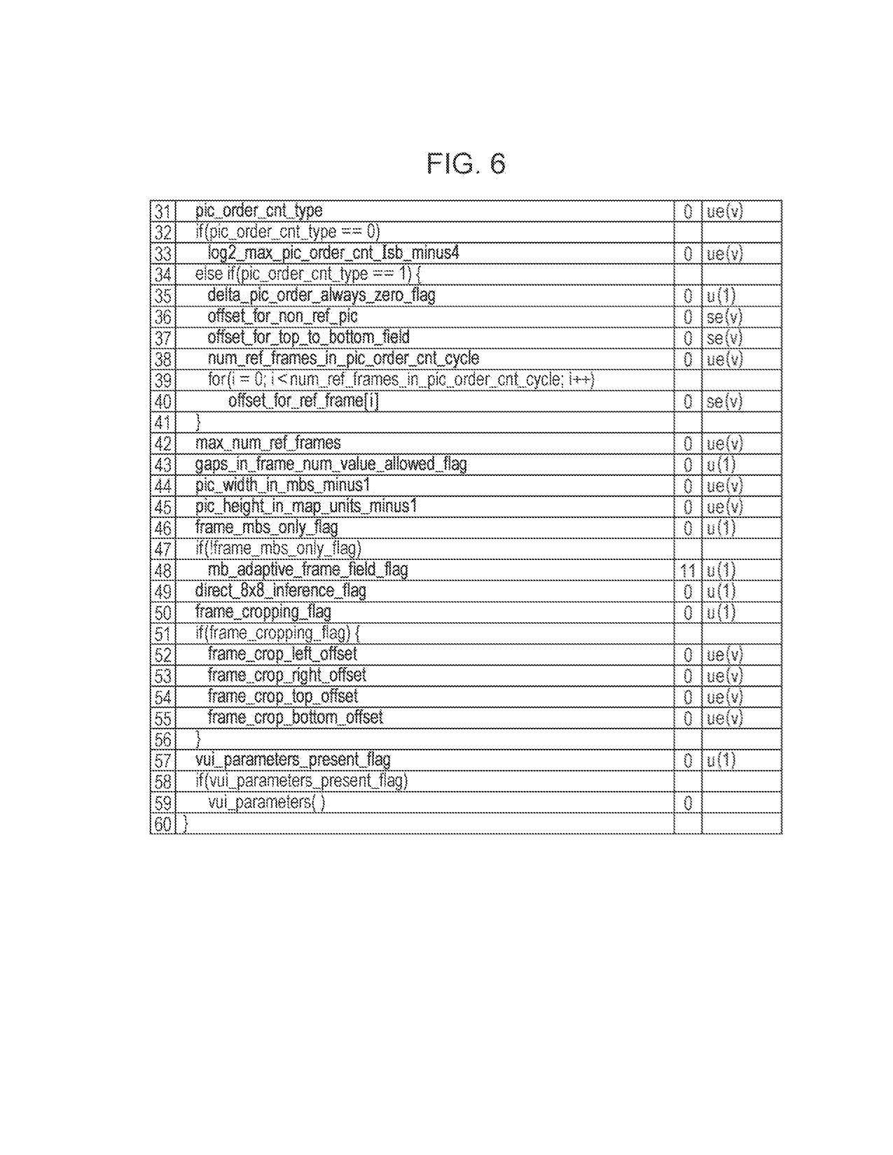

FIGS. 5 and 6 illustrate syntax examples for a sequence parameter set generated by the image encoding apparatus 100. The numerals at the left edge of each line are line numbers added to aid explanation.

In the examples in FIGS. 5 and 6, the frame_mbs_only_flag on line 46 indicates that only frame cooling is to be applied when the value is 1, and indicates that frame/field coding in units of pictures or in units of macro-blocks is to be applied when the value is 0.

When the frame mbs_only_flag on line 46 is 0, the mb_adaptive_frame_field_flag on line 48 is specified. The mb_adaptive_frame_field_flag on line 48 is a flag indicating whether or not to apply frame/field coding in units of macroblock pairs. When the value of the mb_adaptive_frame_field_flag is 1, frame/field coding is applied in units of macroblock pairs.

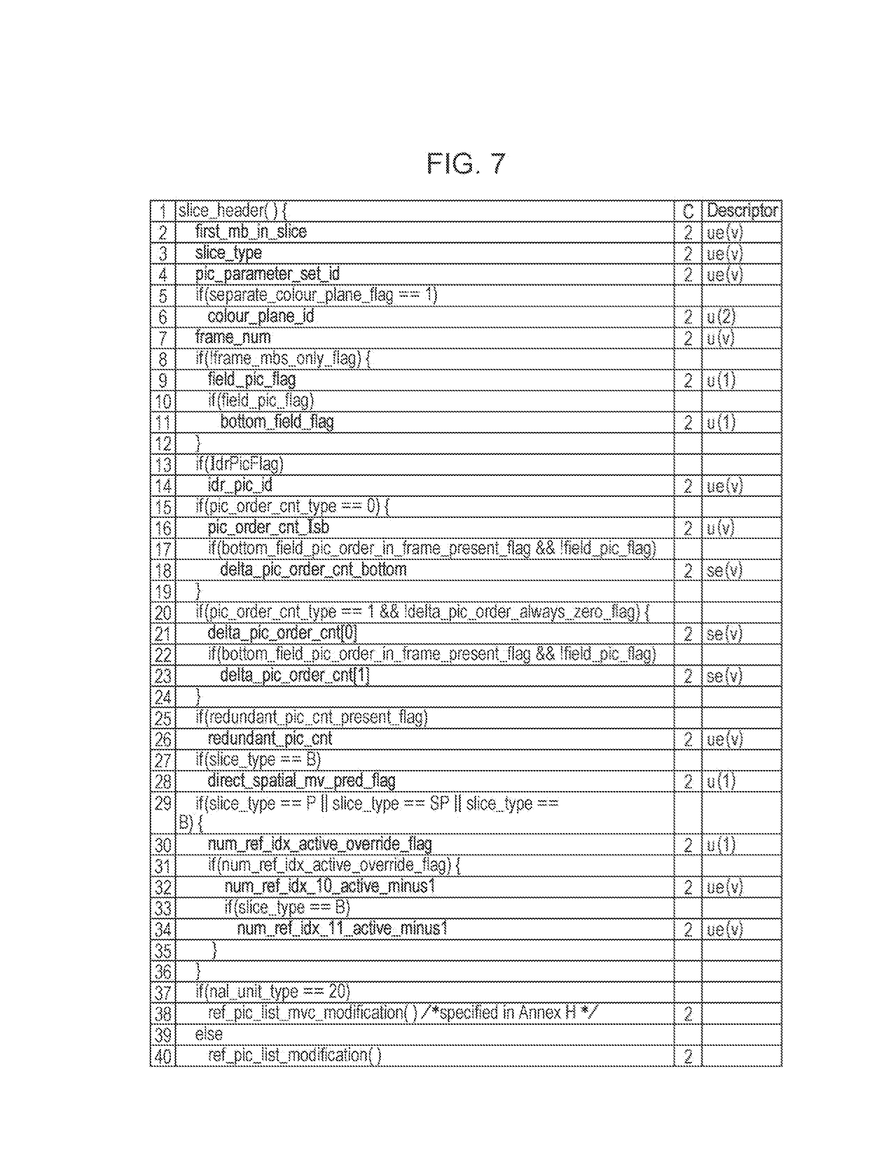

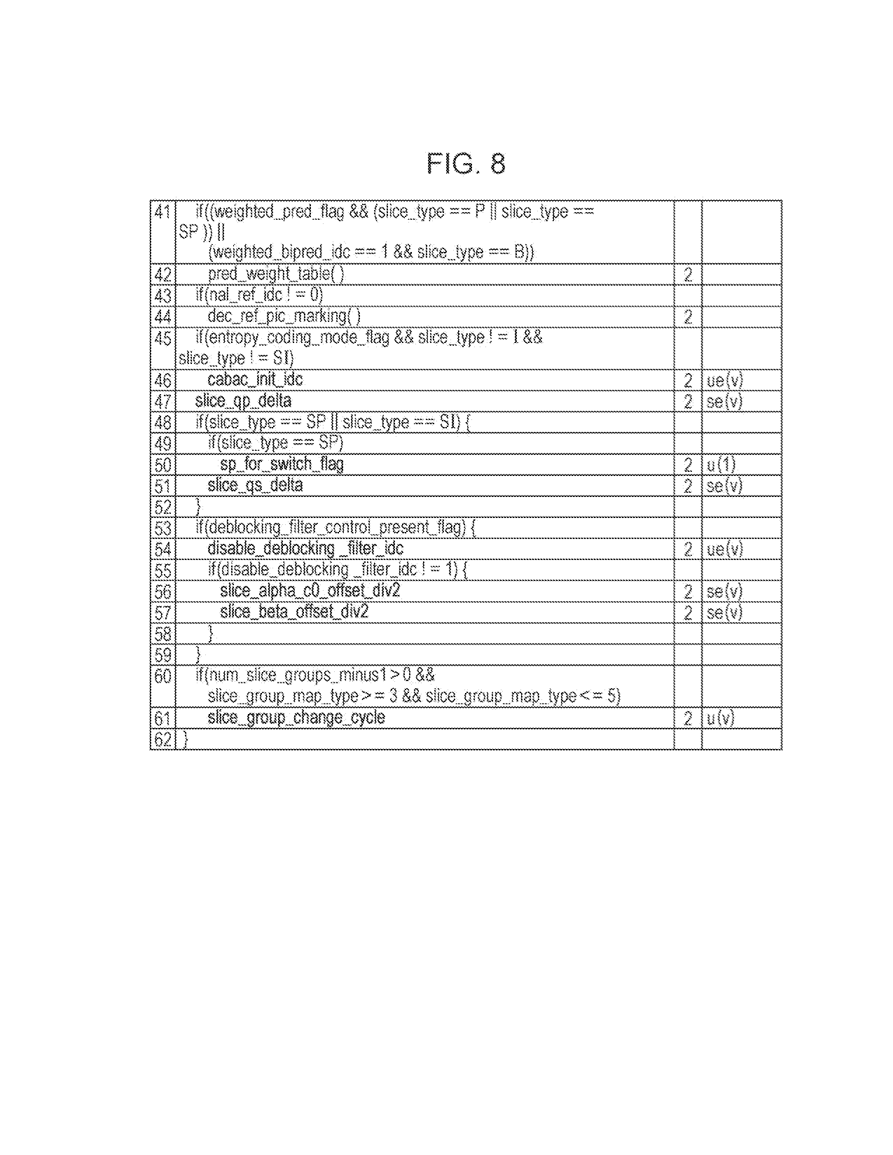

FIGS. 7 and 8 illustrate syntax examples for a slice header generated by the image encoding apparatus 100. The numerals at the left edge of each line are line numbers added to aid explanation.

In the examples in FIGS. 7 and 8, the field_pic_flag on line 9 is a flag that is transmitted, when the frame_mbs_only_flag on line 46 in the above FIGS. 5 and 6 is 0. When the value is 1, the field_pic_flag indicates that, frame/field coding is to be applied in units of pictures as described earlier with reference to FIG. 3.

The bottom_field_flag on line 11 indicates that the corresponding slice is data related to the top field when the value is 0, and indicates that the corresponding slice is data related to the bottom, field, when the value is 1.

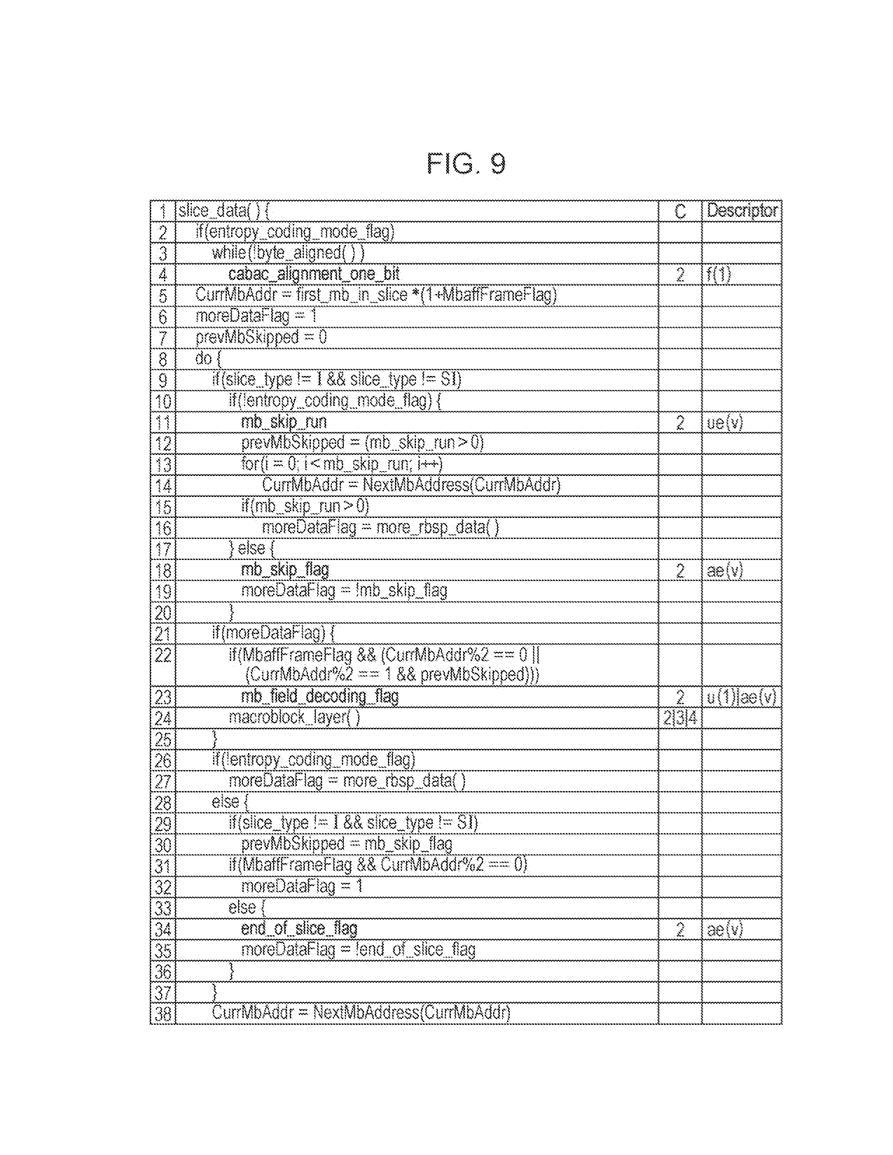

FIG. 9 illustrates syntax examples for slice data generated by the image encoding apparatus 100. The numerals at the left edge of each line are line numbers added to aid explanation.

In the examples in FIG. 9, the mb_field_decoding_flag on line 23 indicates that the corresponding macroblock pair is to be field coded when the value is 1, and indicates that the corresponding macroblock pair is to be frame coded when the value is 0.

Meanwhile, the if statement on line 22 is a syntax element stating that in the case where the mb_field_decoding_flag on line 23 has been sent for one of the macroblocks in a macroblock pair, the flag is not sent for the other macroblock of that macroblock pair.

### Motion Vector Shifting

With the AVC format, the vertical component of the motion vector for the chroma signal is shifted in the case of field coding as discussed earlier with reference to FIG. 3 or 4.

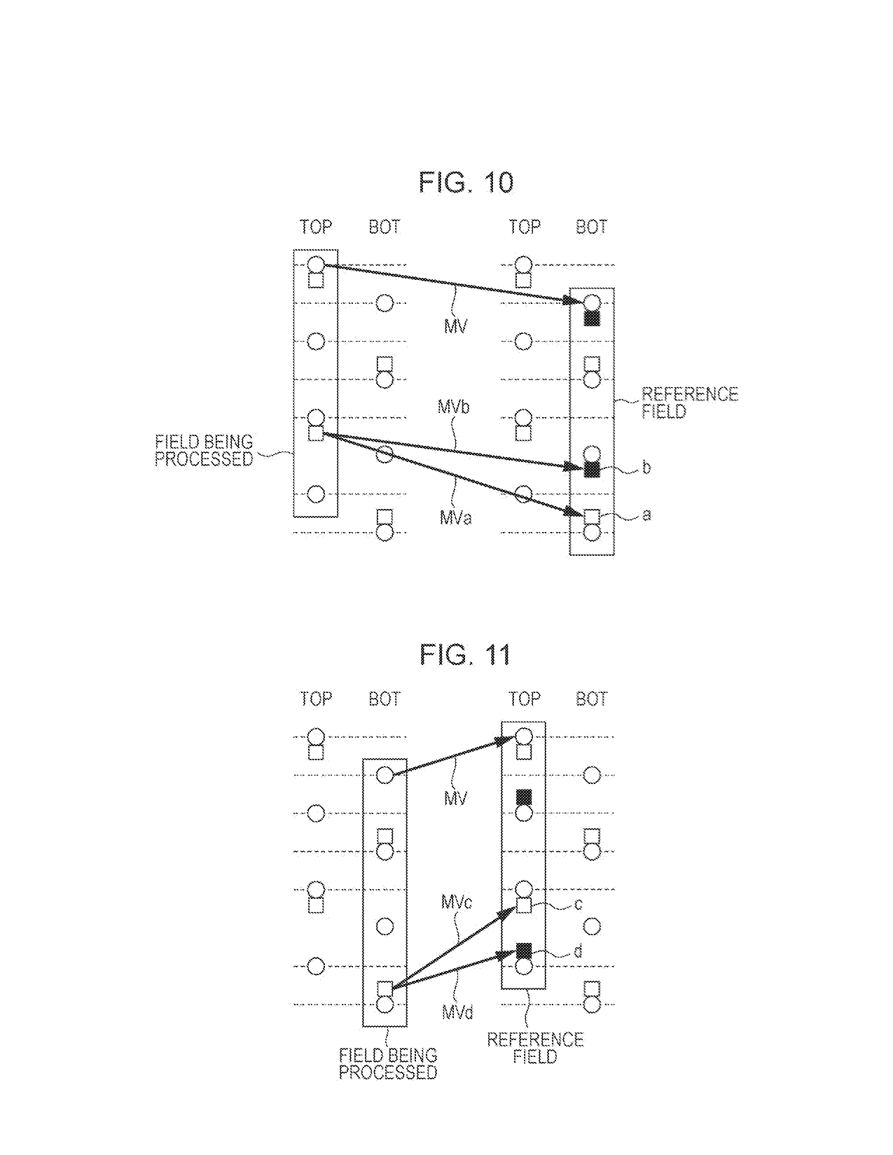

FIG. 10 illustrates exemplary motion vector shifting in the case where the field being processed is a top field, and the reference field is a bottom field. FIG. 11 illustrates exemplary motion vector shifting in the case where the field being processed is a bottom field, and the reference field is a top field.

FIGS. 10 and 11 illustrate examples of the case where the input is 4:2:0 field coded. The broken lines represent the pixel spacing of the luma signal, while the solid rectangles represent, motion compensation blocks (PUs). The white circles represent luma signal pixels, while the white squares represent chroma signal pixels. The black squares represent chroma signal pixels corresponding to chroma signal motion vectors with a shifted vertical component.

For example, in the case where chroma signal pixels in the top field are positioned at the first and third luma signal pixel positions from the top, the chroma signal pixels in the bottom field will be positioned at the second and fourth luma signal pixel positions.

In other words, as illustrated in FIG. 10, if a luma signal motion vector MV is scaled to obtain a chroma signal motion vector MVa, the corresponding chroma signal pixel a will be shifted, by −¼ compared to the luma signal pixel. Consequently, in this case, the chroma signal motion vector MVa is shifted to become the shifted chroma signal motion vector MVb, such that the pixel a is shifted by −¼ and the corresponding chroma signal pixel becomes the pixel b. Thus, the luma signal motion vector MV and the chroma signal motion vector MVb are made to coincide in phase.

Similarly, in FIG. 11, if a luma signal motion vector MV is scaled to obtain a chroma signal motion vector MVc, the corresponding chroma, signal pixel c will be shifted by ¼ compared to the luma signal pixel. Consequently, in this case, the chroma signal motion vector MVc is shifted, to become the shifted chroma signal motion vector MVd, such that the pixel, c is shifted by ¼ and the corresponding chroma signal pixel becomes the pixel d. Thus, the luma signal motion vector MV and the chroma signal motion vector MVd are made to coincide in phase.

As above, frame/field coding, which is a function of the AVC format for interlaced signals as discussed with reference to FIGS. 3 and 4, is also applicable to the HEVC format. However, if frame/field coding in units of macroblock pairs as discussed above with reference to FIG. 4 is applied to the CUs defined in HEVC, the processing becomes complicated, and thus is unrealistic.

In contrast, with the present technology, only frame coding and field coding in units of pictures as illustrated in FIG. 3 are applied. However, if frame coding and field coding as illustrated in FIG. 3 are mixed within the same sequence, deblocking filter application and referential relationships for motion prediction/compensation become more complicated.

Also, with the AVC format, a picture parameter set contains a mixture of parameters used, within the same picture, such as quantization parameters, as well as parameters which may possibly be changed within the same picture, such adaptive loop filter parameters. For this reason, in the case of a change in the latter parameters, the former unchanged parameters are also resent.

### Overview of Present Technology and Syntax Examples

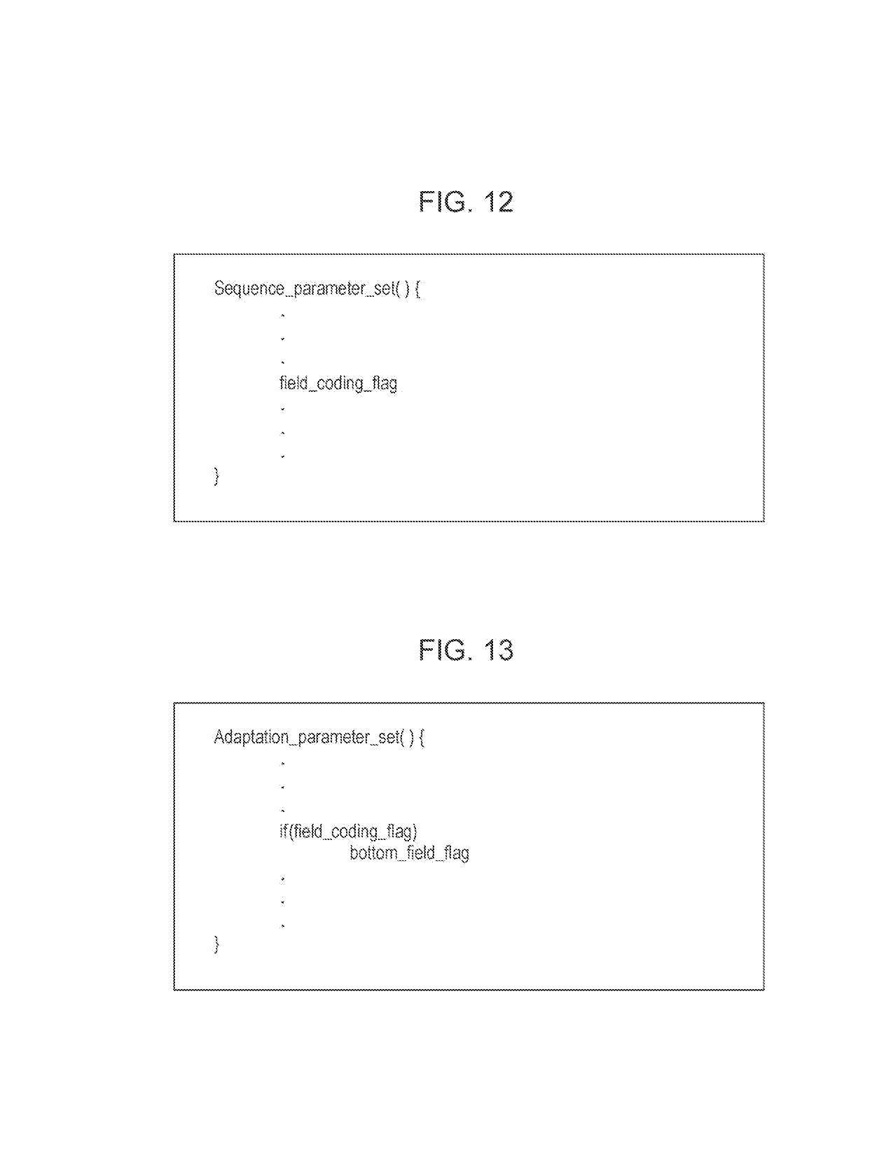

Consequently, in the present technology, a field_coding_flag, which is field coding information indicating whether or not to conduct field coding, is set in the sequence parameter set as illustrated by the syntax element in FIG. 12, and is transmitted to the decoder.

In the case where the field_coding_flag set in the sequence parameter set in FIG. 12 has a value of 1, field coding as discussed earlier with reference to FIG. 3 is applied to the entire sequence being processed. In the case where the field_coding_flag has a value of 0, frame coding is applied to the entire sequence being processed.

Meanwhile, HEVC adopts a syntax element called the adaptation parameter set (APS), which stores parameters applied in units of pictures, such as adaptive loop filter parameters.

Consequently, in the case where the field_coding_flag is 1, a bottom_field_flag, which is parity information indicating whether or not the field is a bottom field, is set in the APS as illustrated by the syntax element in FIG. 13, and is transmitted to the decoder.

The bottom_field_flag set in the APS in FIG. 13 indicates that the corresponding field a top field when the value is 0, and indicates that the corresponding field is a bottom field when the value is 1.

Additionally, in the image encoding apparatus 100, interlace-related coding processing, such as the chroma signal motion vector shifting discussed earlier with reference to FIGS. 10 and 11, is conducted depending on the value of the parity information given by the bottom_field_flag.

In other words, parameters which are uniformly used, within a picture are collected in the picture parameter set, etc. and sent to the decoder. Conversely, the parity information which differs every field is bundled and sent with the APS used to send parameters which may possibly change within a picture, such as adaptive loop filter parameters. In so doing, it is possible to avoid retransmitting the picture parameter set.

Consequently, by applying a syntax structure like the above to HEVC, it becomes possible to reduce syntax redundancies with respect to the AVC format and efficiently encode or decode interlaced signals.

Note that the value of the field_coding_flag may still be 0 even if the input signal is an interlaced signal. In this case, it is possible to transmit supplemental enhanced information (SEI) to the decoder together with the encoded stream, and cause the encoded stream to be output (displayed) as an interlaced signal. In response, at the decoder, decoding corresponding to frame coding is conducted on the basis of the field_coding_flag to generate an image, and the generated image is output (displayed) as an interlaced signal.

### Exemplary Configuration of Interlace Parameter Encoder and Lossless Encoder

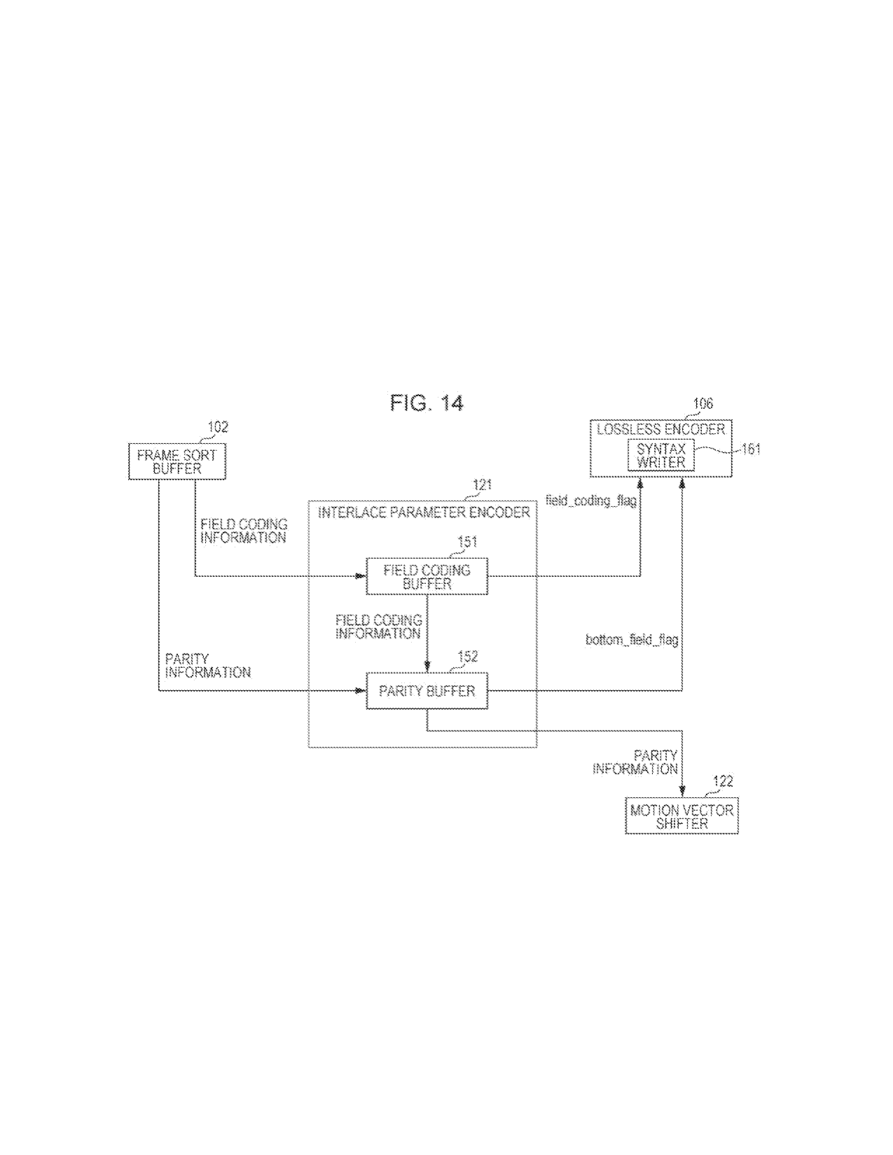

FIG. 14 is a block diagram, illustrating an exemplary primary configuration of the interlace parameter encoder 121 and the lossless encoder 106.

The interlace parameter encoder 121 in the example in FIG. 14 is configured to include a field coding buffer 151 and a parity buffer 152.

The lossless encoder 106 is configured to at least include a syntax writer 161.

From, the frame sort buffer 102 the field coding buffer 151 acquires field coding information indicating whether or not to apply field coding to an image. The acquired field coding information is temporarily stored and supplied to the parity buffer 152 at given timings. At this point, the field coding buffer 151 sets the field coding information as a field coding flag (field_coding_flag), which is supplied to the syntax writer 161.

In the case where the field coding information from the field coding buffer 151 indicates field coding, the parity buffer 152 acquires parity information for each field from the frame sort buffer 102, and temporarily stores the acquired parity information. The parity buffer 152 then supplies the parity information for each field to the motion vector shifter 122 at given timings. At this point, the parity buffer 152 sets the parity information for each field as a parity flag (bottom_field_flag), which is supplied to the syntax writer 161.

The syntax writer 161 adds the field coding flag from the field coding buffer 151 to the sequence parameter set in the encoded stream as illustrated in FIG. 12. The syntax writer 161 also adds the parity flag from the parity buffer 152 to the APS in the encoded stream as illustrated in FIG. 13.

Meanwhile, upon acquiring the parity information for each, field from the parity buffer 152, the motion vector shifter 122 acquires luma signal motion vector information from the motion prediction/compensation unit 115, and shifts the chroma signal motion vectors. In other words, chroma signal motion vectors are shifted using luma signal motion vector information from the motion prediction/compensation unit 115 on the basis of acquired parity information for each field, as discussed earlier with reference to FIG. 10.

### Encoding Process Flow

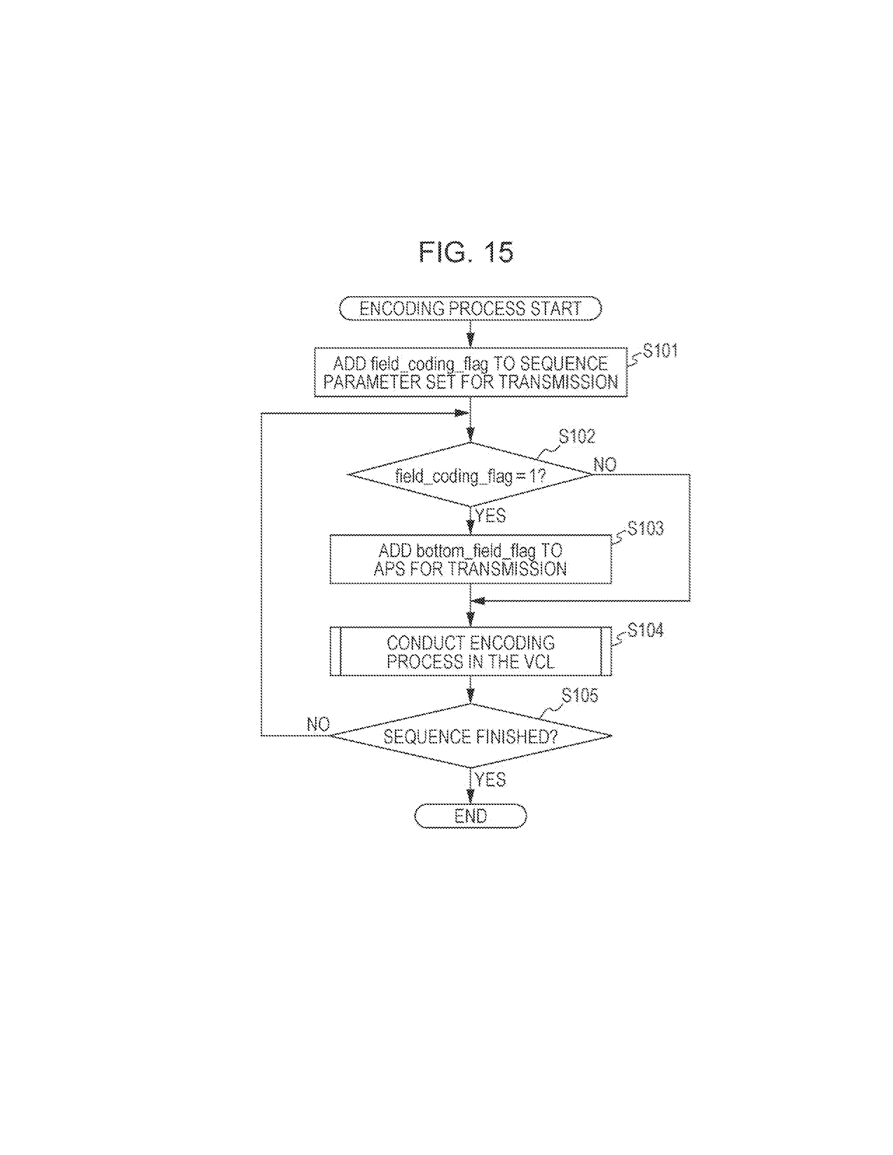

Next, the flow of processes executed by an image encoding apparatus 100 like the above will be described. First, an exemplary encoding process flow will be described with reference to the flowchart in FIG. 15.

In the case where the input image is an interlaced signal, field coding information indicating whether or not to conduct field coding is input into the frame sort buffer 102 via a user input unit or other means not illustrated in the drawings. The frame sort buffer 102 sorts frames on the basis of the field, coding information, and also supplies the field coding information to the field coding buffer 151.

From the frame sort buffer 102 the field coding buffer 151 acquires field coding information indicating whether or not to apply field coding to an image, and temporarily stores the acquired field coding information. The field coding buffer 151 then supplies the stored field coding information to the syntax writer 161 as the field_coding_flag.

In response, in step S101 the syntax writer 161 adds the field_coding_flag to the sequence parameter set of the encoded stream for transmission. In other words, the field_coding_flag is added to the sequence parameter set in the encoded stream as illustrated in FIG. 12.

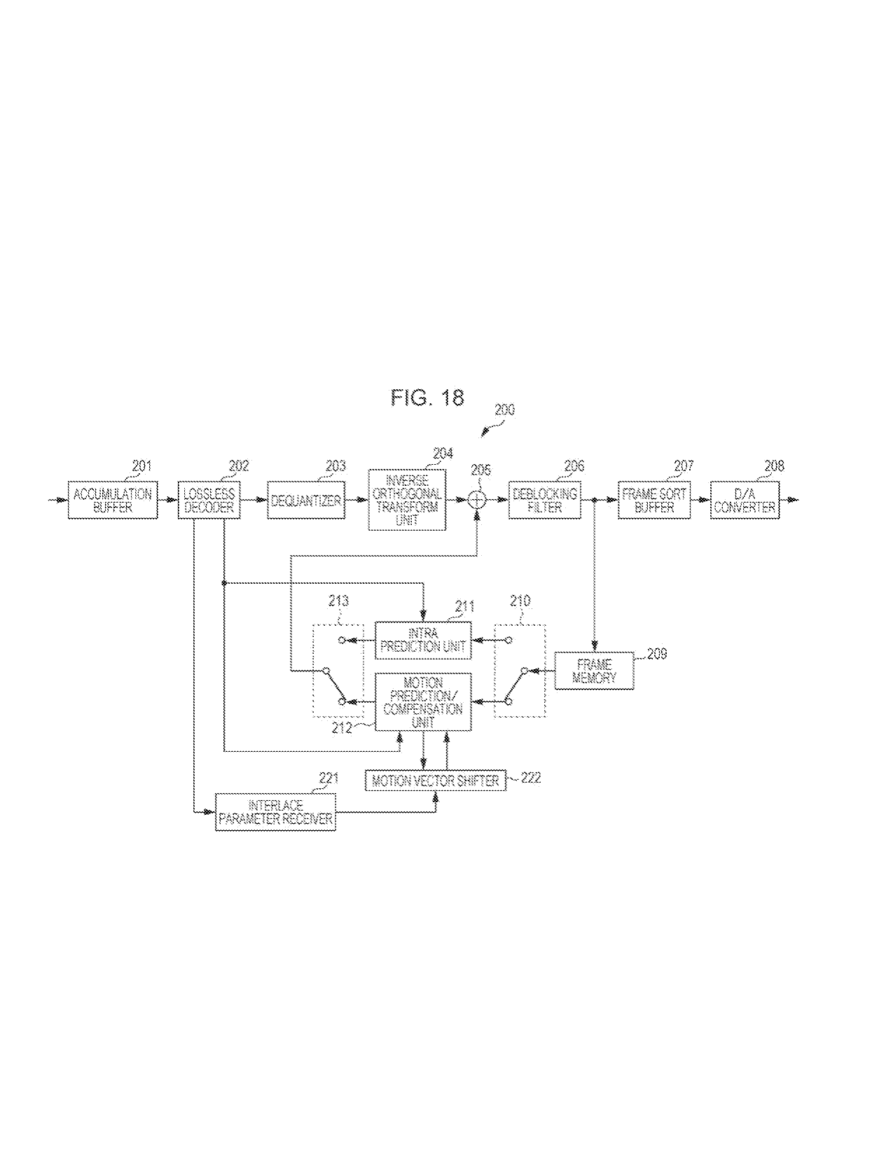

The encoded, stream with the field_coding_flag added, to the sequence parameter set is supplied to the accumulation buffer 107 and transmitted to an image decoding apparatus 200 in FIG. 18, to be discussed later.

In step S102, the syntax writer 161 determines whether or not the field_coding_flag is 1. The process proceeds to step S103 in the case where it is determined in step S102 that the field_coding_flag is 1, or in other words, that the current sequence is to be field coded.

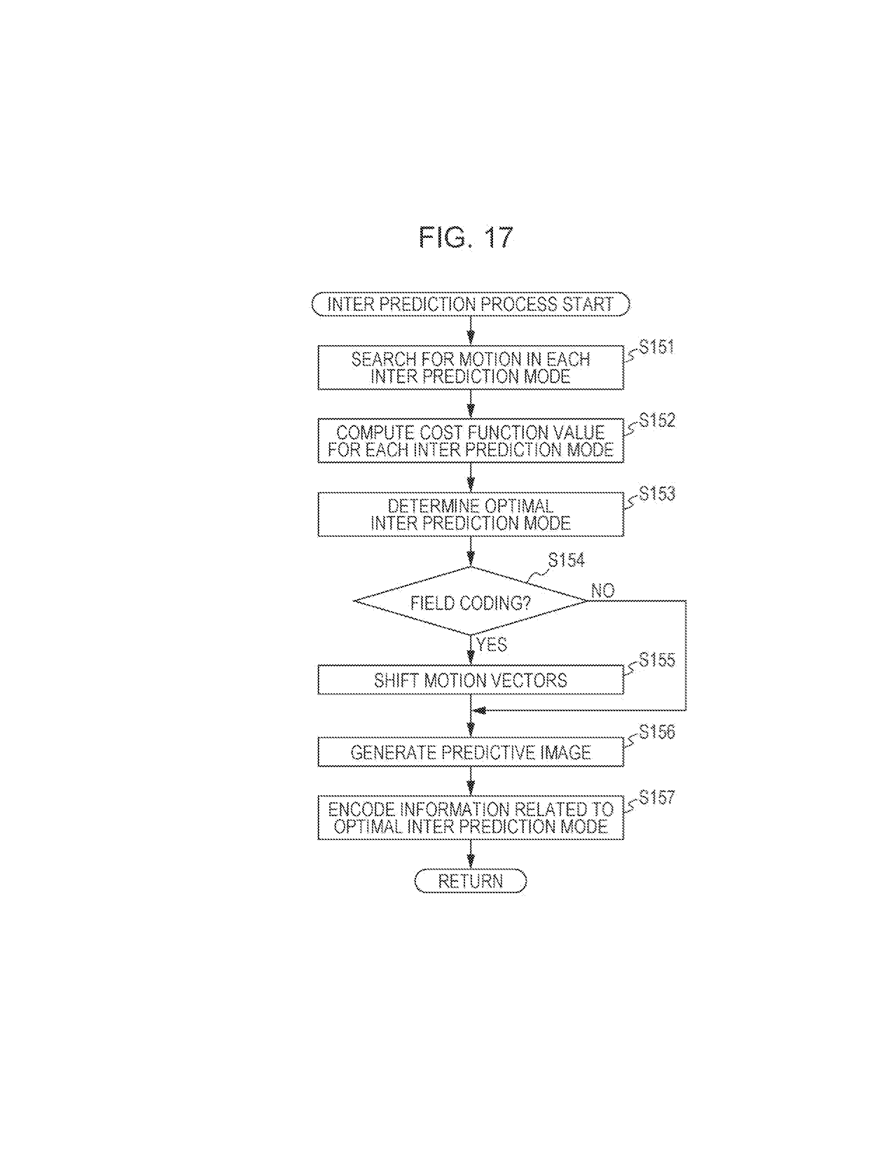

In the case of field coding, the frame sort buffer 102 additionally supplies per-field parity information to the parity buffer 152. From the frame sort buffer 102 the parity buffer 152 acquires parity information for each field, and temporarily stores the acquired parity information. The parity buffer 152 then supplies the stored parity information to the syntax writer 161 as the bottom_field_flag. At this point, the parity information is also supplied to the motion vector shifter 122 for use in step S155 of FIG. 17, to be discussed later.

In step S103, the syntax writer 161 adds the bottom_field_flag to the APS of the encoded stream for transmission. In other words, the bottom_field_flag is added to the APS in the encoded stream as illustrated in FIG. 13.

The encoded, stream with the bottom_field_flag added, to the APS is supplied to the accumulation buffer 107 and transmitted to the image decoding apparatus 200 in FIG. 18, to be discussed, later.

Meanwhile, step S103 is skipped, and the process proceeds to step S104 in the case where it is determined in step S102 that the field_coding_flag is not 1, or in other words, that the current sequence is to be frame coded.

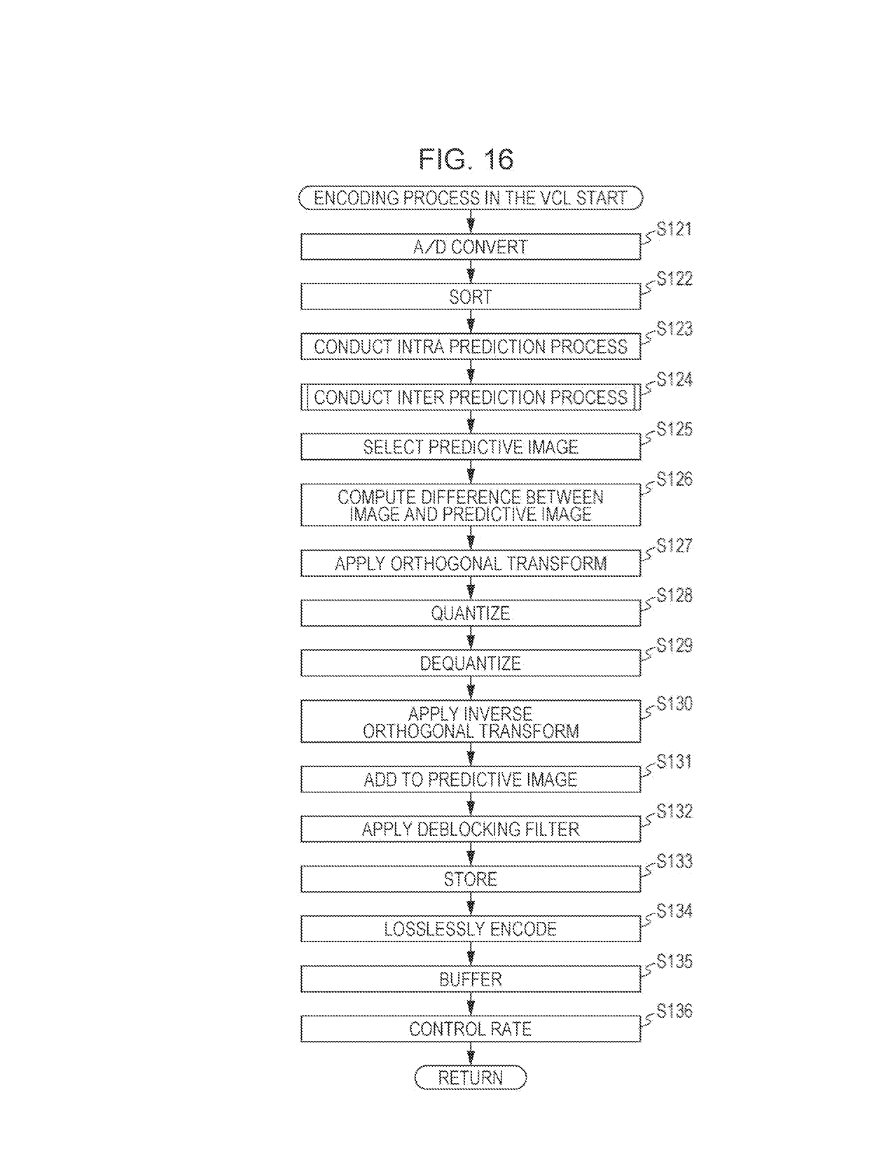

In step S104, the respective units of the image encoding apparatus 100 conduct an encoding process in the video coding layer (VCL). The encoding process in the VCL refers to the encoding of information under the slice headers, such as DCT coefficients and motion vectors. This encoding process in the VCL will be discussed later with reference to FIG. 16.

Due to the encoding process in the VCL of step S104, information in and below the VCL is encoded and transmitted to the image decoding apparatus 200.

In step S105, the syntax writer 161 determines whether or not the sequence has finished. If it is determined in step S105 that the sequence has not finished, the process returns to step S102, and the processing thereafter is repeated.

If it is determined in step S105 that the sequence has finished, the encoding process of the image encoding apparatus 100 ends.

### Flow of Encoding Process in the VCL

Next, the encoding process in the VCL in step S104 of FIG. 15 will be described with reference to the flowchart in FIG. 16.

In step S121, the A/D converter 101 A/D converts input images. In step S122, the frame sort buffer 102 stores the A/D converted images, resorting pictures from their display order to an encoding order. In step S123, the intra prediction unit 114 conducts an intra prediction process in intra prediction modes.

In step S124, the motion prediction/compensation unit 115 conducts an inter prediction process that conducts motion prediction and motion compensation in inter prediction modes. The inter prediction process will be described later in detail with reference to FIG. 17.

According to the processing in step S124, luma signal motion vectors for the PU being processed are found, cost function values are calculated, and an optimal inter prediction mode is determined from among all inter prediction modes. Then, a predictive image is generated in the optimal inter prediction mode. Meanwhile, in the case of field coding, the chroma signal motion vectors are shifted, and a predictive image is generated using the luma signal motion vectors and the shifted chroma signal motion vectors.

The predictive image and cost function value of the optimal inter prediction mode thus determined is supplied to the predictive image selector 116 from the motion prediction/compensation unit 115. Additionally, information on the optimal inter prediction mode thus determined and motion vector information is supplied to the lossless encoder 106 and losslessly encoded in a step S134, to be discussed later.

In step S125, the predictive image selector 116 determines the optimal mode on the basis of the cost function values output from the intra prediction unit 114 and the motion prediction/compensation unit 115. In other words, the predictive image selector 116 selects either the predictive image generated by the intra prediction unit 114, or the predictive image generated by the motion prediction/compensation unit 115.

In step S126, the arithmetic unit 103 calculates the difference between a image that was sorted by the processing in step S122 and the predictive image selected by the processing in step S125. With differential data, the data size is reduced compared to the original image data. Consequently, the data size can be compressed compared to the case of encoding images directly.

In step S127, the orthogonal transform unit 104 orthogonally transforms the difference information generated by the processing in step S126. Specifically, an orthogonal transform such as the discrete cosine transform or the Karhunen-Loeve transform is applied, and transform coefficients are output.

In step S128, the quantizer 105 quantizes the orthogonal transform coefficients obtained by the processing in step S127, using quantization parameters from the rate controller 117.

The difference information quantized by the processing in step S128 is locally decoded as follows. In step S129, the dequantizer 108 dequantizes the quantized orthogonal transform coefficients generated by the processing in step S128 (also referred to as the quantized coefficients), using characteristics that correspond to the characteristics of the quantizer 105. In step S130, the inverse orthogonal transform unit 109 inverse orthogonally transforms the orthogonal transform coefficients obtained by the processing in step S129, using characteristics that correspond to the characteristics of the orthogonal transform unit 104.

In step S131, the arithmetic unit 110 adds the predictive image to the locally decoded difference information, and generates a locally decoded image (i.e., an image corresponding to the input into the arithmetic unit 103). In step S132, the deblocking filter 111 applies deblocking filtering as appropriate to the locally decoded image obtained by the processing in step S131.

In step S133, the frame memory 112 stores the decoded image that was subjected to deblocking filtering by the processing in step S132. However, images which are not filtered by the deblocking filter 111 are also supplied, to the frame memory 112 from the arithmetic unit 110 and stored.

In step S134, the lossless encoder 106 encodes the transform coefficients quantized by the processing in step S128. In other words, lossless encoding such as variable-length coding or arithmetic coding is applied to a differential image.

Also, at this point the lossless encoder 106 encodes information related to the prediction mode of the predictive image selected by the processing in step S125, and adds the encoded information to the encoded data obtained by encoding the differential image. In other words, the lossless encoder 106 also encodes information such as optimal intra prediction mode information supplied, from the intra prediction unit 114 or optimal inter prediction mode information supplied from the motion prediction/compensation unit 115, and adds the encoded information to the encoded data.

In step S135, the accumulation buffer 107 buffers the encoded data obtained by the processing in step S134. The encoded data buffered in the accumulation buffer 107 is read out as appropriate and transmitted to the decoder via a transmission channel or recording medium.

In step S136, the rate controller 117 controls the rate of quantization operations by the quantizer 105 on the basis of the bit rate of encoded data buffered in the accumulation buffer 107 by the processing in step S135, such that overflows or underflows do not occur.

Once the processing in step S136 is finished, the encoding process ends.

### Inter Prediction Process Flow

Next, an exemplary flow of the inter prediction process executed in step S124 of FIG. 16 will be described with reference to the flowchart in FIG. 17.

In step S151, the motion prediction/compensation unit 115 searches for motion in each inter prediction mode.

In step S152, the motion prediction/compensation unit 115 uses information such as an input image from the frame sort buffer 102 and found motion vector information to compute a cost function value related to each inter prediction mode.

In step S153, the motion prediction/compensation unit 115 determines the prediction mode with the minimum cost function value from among the respective prediction modes to be the optimal inter prediction mode. Luma signal motion vector information and information related to reference PUs in the optimal inter prediction mode are supplied by the motion prediction/compensation unit 115 to the motion vector shifter 122.

Meanwhile, per-sequence field coding information from the field coding buffer 151 is supplied to the parity buffer 152.

In step S154, the parity buffer 152 determines whether or not the current sequence is to be field coded, on the basis of the field coding information from the field coding buffer 151. The process proceeds to step S155 in the case where it is determined in step S154 that the current sequence is to be field coded. At this point, for each field, the parity buffer 152 supplies the motion vector shifter 122 with per-field parity information from the frame sort buffer 102.

In step S155, the motion vector shifter 122 shifts chroma signal motion vectors. In other words, the luma signal motion vector information from the motion prediction/compensation unit 115 is scaled to generate chroma signal motion vectors. Then, the chroma signal motion vectors are shifted by the processing in step S155, such that the vertical components of the chroma signal motion vectors are shifted on the basis of the per-field parity information as discussed earlier with reference to FIG. 10. The motion vector shifter 122 supplies the shifted chroma signal motion vector information to the motion prediction/compensation unit 115.

Step S155 is skipped and the process proceeds to step S156 in the case where it is determined in step S154 that the current sequence is to be frame coded. In other words, in this case, the chroma signal motion vectors generated by scaling the luma signal motion vectors are used in the next step S156 without being shifted.

In step S156, the motion prediction/compensation unit 115 uses the luma signal and chroma signal motion vector information to generate a predictive image in the optimal inter prediction mode, which is supplied to the predictive image selector 116.

In step S157, the motion prediction/compensation unit 115 supplies information related to the optimal inter prediction mode to the lossless encoder 106, causing the information related to the optimal inter prediction mode to be encoded.

Note that the information related to the optimal inter prediction mode may include optimal inter prediction mode information, information related to motion vectors, and optimal inter prediction mode reference picture information, for example.

In response to the processing in step S156, the supplied information is encoded in step S134 of FIG. 16.

As above, in the image encoding apparatus 100, it is determined whether or not to conduct field coding for the entire sequence, and a flag indicating whether or not to conduct field, coding is added to the sequence parameter set of the encoded stream and transmitted to the decoder.

In the case where field coding is determined, per-field parity information is used, motion vectors may be shifted, for example, and a flag indicating parity information is added to the APS of the encoded stream and transmitted to the decoder.

In so doing, an encoding process can be efficiently conducted without additional complexity in the case where the input is an interlaced signal.

### 2. Second Embodiment

### Image Decoding Apparatus

Next, the decoding of encoded data that has been encoded as above (an encoded stream) will be described. FIG. 18 is a block diagram illustrating an exemplary primary configuration of an image decoding apparatus corresponding to the image encoding apparatus 100 in FIG. 1.

The image decoding apparatus 200 illustrated in FIG. 18 decodes encoded data generated by the image encoding apparatus 100 according to a decoding method that corresponds to that encoding method. Herein, the image decoding apparatus 200 is taken to inter predict in units of prediction units (PUs), similarly to the image encoding apparatus 100.

As illustrated in FIG. 22, the image decoding apparatus 200 includes an accumulation buffer 201, a lossless decoder 202, a dequantizer 203, an inverse orthogonal transform unit 204, an arithmetic unit 205, a deblocking filter 206, a frame sort buffer 207, and a D/A converter 208. Additionally, the image decoding apparatus 200 includes frame memory 209, a selector 210, an intra prediction unit 211, a motion prediction/compensation unit 212, and a selector 213.

The image decoding apparatus 200 additionally includes an interlace parameter receiver 221 and a motion vector shifter 222.

The accumulation buffer 201 is also a receiver that receives encoded data transmitted thereto. The accumulation buffer 201 receives and buffers encoded data transmitted thereto, and supplies the encoded data to the lossless decoder 202 at given timings.

In the sequence parameter set of the encoded data, a flag indicating whether or not to conduct field coding (field_coding_flag) is included for each sequence. Also, in the case of conducting field coding, a flag expressing field parity information (bottom_field_flag) is included in the APS of the encoded, data.

The lossless decoder 202 supplies the field, coding flags and any field parity flags to the interlace parameter receiver 221.

Additionally, besides DCT coefficients, decoding-related information such as prediction mode information and motion vector information is included in the VCL information under the slice headers of the encoded data. The lossless decoder 202 decodes information that has been encoded by the lossless encoder 106 in FIG. 1 and supplied by the accumulation buffer 201, according to a format that corresponds to the encoding format of the lossless encoder 106. The lossless decoder 202 supplies quantized coefficient data for a differential image obtained by decoding to the dequantizer 203.

The lossless decoder 202 also determines whether an intra prediction mode or an inter prediction mode has been selected for the optimal prediction mode. The lossless decoder 202 supplies information related to the optimal prediction mode to the intra prediction unit 211 or the motion prediction/compensation unit 212 depending on the mode which is determined to have been selected. In other words, in the case where an inter prediction mode was selected as the optimal prediction mode in the image encoding apparatus 100, for example, information related to that, optimal prediction mode is supplied to the motion prediction/compensation unit 212.

The dequantizer 203 takes the quantized coefficient data obtained by decoding in the lossless decoder 202, and dequantizes the quantized coefficient data in a format corresponding to the quantization format of the quantizer 105 in FIG. 1. The obtained coefficient data is supplied to the inverse orthogonal transform unit 204.

The inverse orthogonal transform unit 204 applies an inverse orthogonal transform to the coefficient data supplied from the dequantizer 203, in a format corresponding to the orthogonal transform format of the orthogonal transform unit 104 in FIG. 1. By applying an inverse orthogonal transform, the inverse orthogonal transform unit 204 obtains decoded residual data corresponding to the residual data prior to the orthogonal transform in the image encoding apparatus 100.

The decoded residual data obtained by applying the inverse orthogonal transform is supplied to the arithmetic unit 205. The arithmetic unit 205 is also supplied with a predictive image from the intra prediction unit 211 or the motion prediction/compensation unit 212 via the selector 213.

The arithmetic unit 205 adds the decoded residual data to the predictive image, and obtains decoded image data corresponding to the image data before a predictive image was subtracted by the arithmetic unit 103 of the image encoding apparatus 100. The arithmetic unit 205 supplies the decoded image data to the deblocking filter 206.

The deblocking filter 206 applies deblocking filtering as appropriate to the decoded image supplied thereto, and supplies the result to the frame sort buffer 207. The deblocking filter 206 removes blocking artifacts from the decoded image by applying deblocking filtering to the decoded image.

The deblocking filter 206 supplies the filtered result (i.e., the decoded image after the filtering) to the frame sort, buffer 207 and the frame memory 209. However, a decoded image output from the arithmetic unit 205 may also be supplied to the frame sort buffer 207 and the frame memory 209, bypassing the deblocking filter 206. In other words, the filtering by the deblocking filter 206 may be omitted.

The frame sort buffer 207 sorts images. Although not illustrated in FIG. 18, the frame sort buffer 207 is supplied with field, coding information from a source such as the interlace parameter receiver 221, and sorts images on the basis of the field coding information. In other words, the frame sequence that was resorted into an encoding order by the frame sort buffer 102 in FIG. 1 is resorted into the original display order. The D/A converter 208 D/A converts images supplied from the frame sort buffer 207, and outputs the images to a display (not illustrated) to be displayed.

The frame memory 209 stores supplied decoded images, and at given timings or on the basis of external requests from units such as the intra prediction unit 211 or the motion prediction/compensation unit 212, supplies the stored decoded images to the selector 210 as reference images.

The selector 210 selects a supply destination for a reference image supplied from the frame memory 209. In the case of decoding an intra coded image, the selector 210 supplies the intra prediction unit 211 with a reference image supplied from the frame memory 209. Alternatively, in the case of decoding an inter coded, image, the selector 210 supplies the motion prediction/compensation unit 212 with a reference image supplied from the frame memory 209.

The intra prediction unit 211 is supplied with information indicating an intra prediction mode from the lossless decoder 202 as appropriate, the information being obtained by decoding header information. The intra prediction unit 211 generates a predictive image by conducting intra prediction using the reference image acquired from the frame memory 209 in the intra prediction mode used by the intra prediction unit 114 in FIG. 1. The intra prediction unit 211 supplies the generated predictive image to the selector 213.

The motion prediction/compensation unit 212 acquires information obtained by decoding header information (such as optimal, prediction mode information, motion vector information, and reference image information) from the lossless decoder 202.

The motion prediction/compensation unit 212 generates a predictive image by conducting inter prediction using the reference image acquired from the frame memory 209 in the inter prediction mode indicated by the optimal prediction mode information acquired from the lossless decoder 202. In the case of field cooing, luma signal motion vector information and information related, to reference PUs is supplied to the motion vector shifter 222. In response, chroma signal motion vectors shifted by the motion vector shifter 222 are supplied to the motion prediction/compensation unit 212, and the shifted chroma signal motion vectors are used in the generation of the predictive image.

The selector 213 supplies the arithmetic unit 205 with a predictive image from the intra prediction unit 211 or a predictive image from the motion prediction/compensation unit 212. Then, in the arithmetic unit 205, the predictive image generated using the motion vectors is added to the decoded residual data (differential image information) from the inverse orthogonal transform unit 204, and the original image is decoded. In other words, the motion prediction/compensation unit 212, the lossless decoder 202, the dequantizer 203, the inverse orthogonal transform unit 204, and the arithmetic unit 205 are also a decoding unit that uses motion vectors to decode encoded data and generate an original image.

The interlace parameter receiver 221 is basically configured similarly to the interlace parameter encoder 121 in FIG. 1. The interlace parameter receiver 221 acquires a field coding flag indicating whether or not to conduct field coding on a particular sequence from the lossless decoder 202. At given timings, the interlace parameter receiver 221 supplies the acquired field coding flag to the motion vector shifter 222 as field coding information.

Additionally, in the case where the field coding information indicates that field coding is to be conducted, the interlace parameter receiver 221 acquires a parity flag for each field from the lossless decoder 202. At given timings, the interlace parameter receiver 221 supplies the acquired parity flag to the motion vector shifter 222 as parity information.

The motion vector shifter 222 is basically configured similarly to the motion vector shifter 122 in FIG. 1. Upon acquiring the parity information for each field from the interlace parameter receiver 221, the motion vector shifter 222 acquires luma signal motion vector information from the motion prediction/compensation unit 212.

Using the acquired luma signal motion vector information, the motion vector shifter 222 shifts the chroma signal motion vectors according to the per-field parity information from the interlace parameter receiver 221. In other words, the motion vector shifter 222 likewise shifts motion vectors as discussed earlier with reference to FIG. 10. At this point, information regarding reference PUs is also acquired from the motion prediction/compensation unit 212 and used for processing. The motion vector shifter 222 supplies the shifted chroma signal motion vector information to the motion prediction/compensation unit 212.

### Exemplary Configuration of Lossless Decoder and Interlace Parameter Receiver

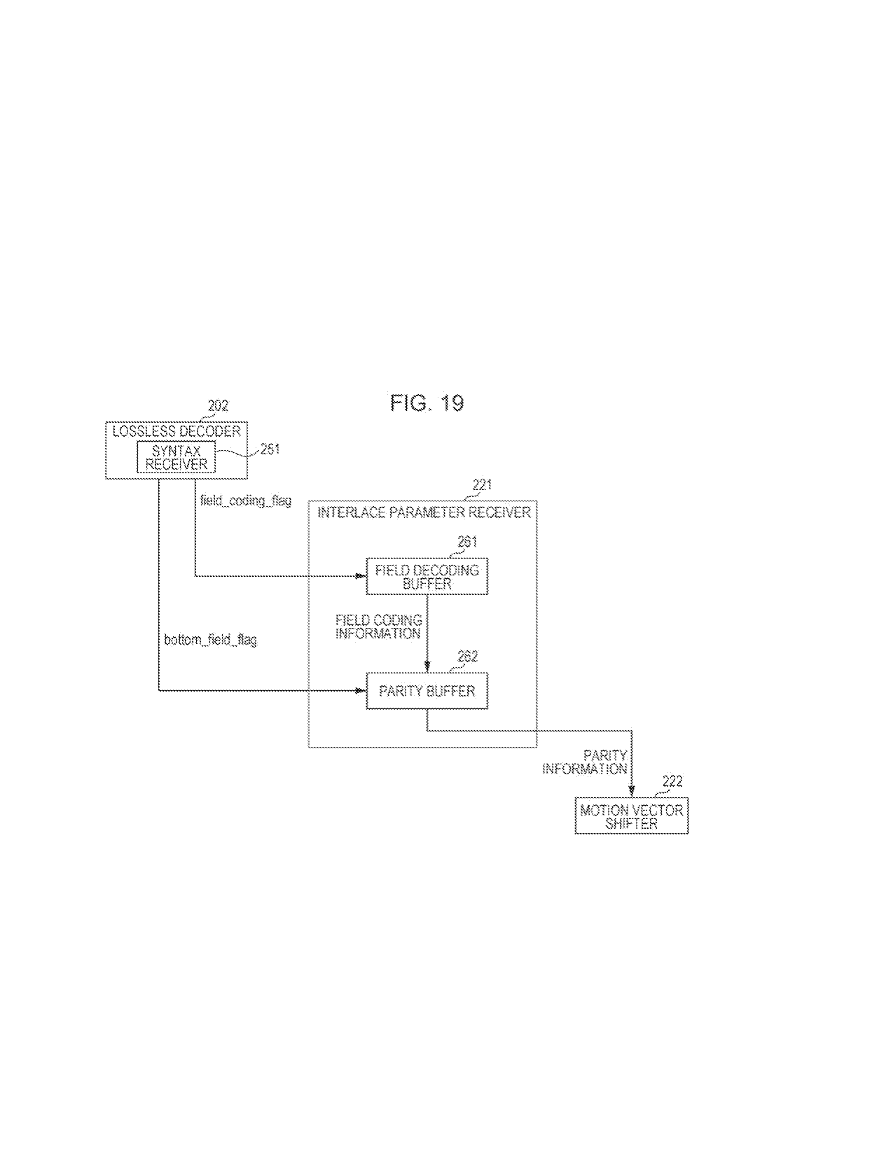

FIG. 19 is a block diagram illustrating an exemplary primary configuration of the lossless decoder 202 and the interlace parameter receiver 221.

In the example in FIG. 19, the lossless decoder 202 is configured to include a syntax receiver 251.

The interlace parameter receiver 221 is configured to include a field decoding buffer 261 and a parity buffer 262.

The syntax receiver 251 acquires a field coding flag from the sequence parameter set of the encoded stream which indicates whether or not the sequence is field coded, and supplies the acquired flag to the field decoding buffer 261. Also, in the case where the sequence is field coded, the syntax receiver 251 acquires a parity flag for each field from the APS of the field coded encoded stream, and supplies the acquired parity flags to the parity buffer 262.

The field decoding buffer 261 acquires the field, coding flag from, the syntax receiver 251, temporarily stores the field coding flag as field coding information, and supplies the field coding information to the parity buffer 262 at given timings.

In the case where the field coding information from the field decoding buffer 261 indicates field coding, the parity buffer 262 acquires a parity flag for each field from the syntax receiver 251, and temporarily stores the acquired parity flags as parity information. Then, for each field, the parity buffer 262 supplies parity information for that field to the motion vector shifter 222.

In response, upon acquiring the per-field parity information from the parity buffer 262, the motion vector shifter 222 acquires luma signal motion vector information from the motion prediction/compensation unit 212, and shifts the chroma signal motion vectors. In other words, chroma signal motion vectors are shifted using luma signal motion vector information from the motion prediction/compensation unit 212 on the basis of acquired parity information for each field, as discussed earlier with reference to FIG. 10.

### Decoding Process Flow

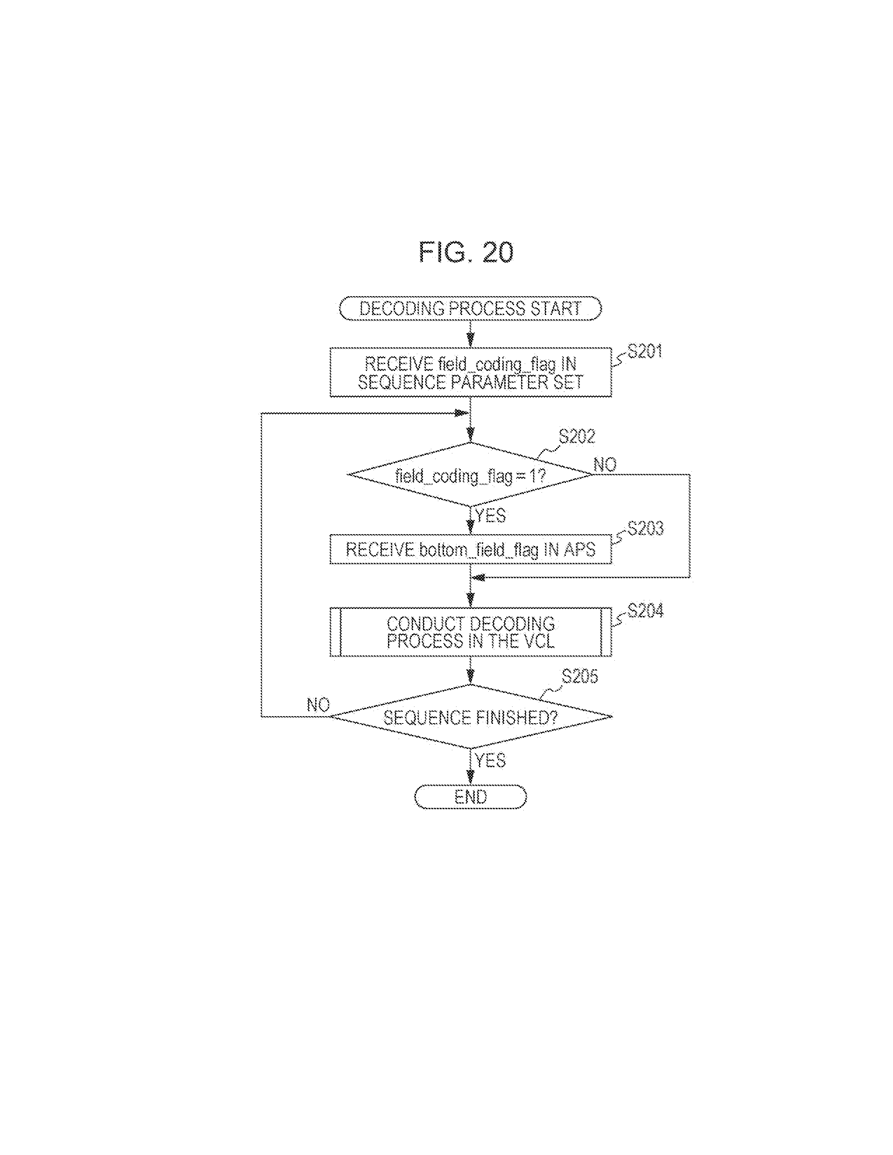

Next, the flow of processes executed by an image decoding apparatus 200 like that above will be described. First, an exemplary decoding process flow will be described with reference to the flowchart, in FIG. 20.

In step S201, the syntax receiver 251 receives, from the sequence parameter set of the encoded stream, a flag (field_coding_flag) expressing field coding information which indicates whether or not the sequence is field coded. The syntax receiver 251 supplies the received flag to the field decoding buffer 261.

In step S202, the syntax receiver 251 determines whether or not the flag indicating field coding or not that was received in step S201 has a value of 1. The process proceeds to step S203 in the case where it is determined in step S202 that the flag is 1, or in other words, that the sequence is field coded.

In step S203, the syntax receiver 251 receives a flag (bottom_field_flag) expressing parity information for a particular field in the APS of the encoded stream, and supplies the receive parity flag to the parity buffer 262.

Meanwhile, step S203 is skipped and the process proceeds to step S204 in the case where it is determined that the flag indicating field coding or not is not 1, or in other words, that, the current sequence is frame coded.

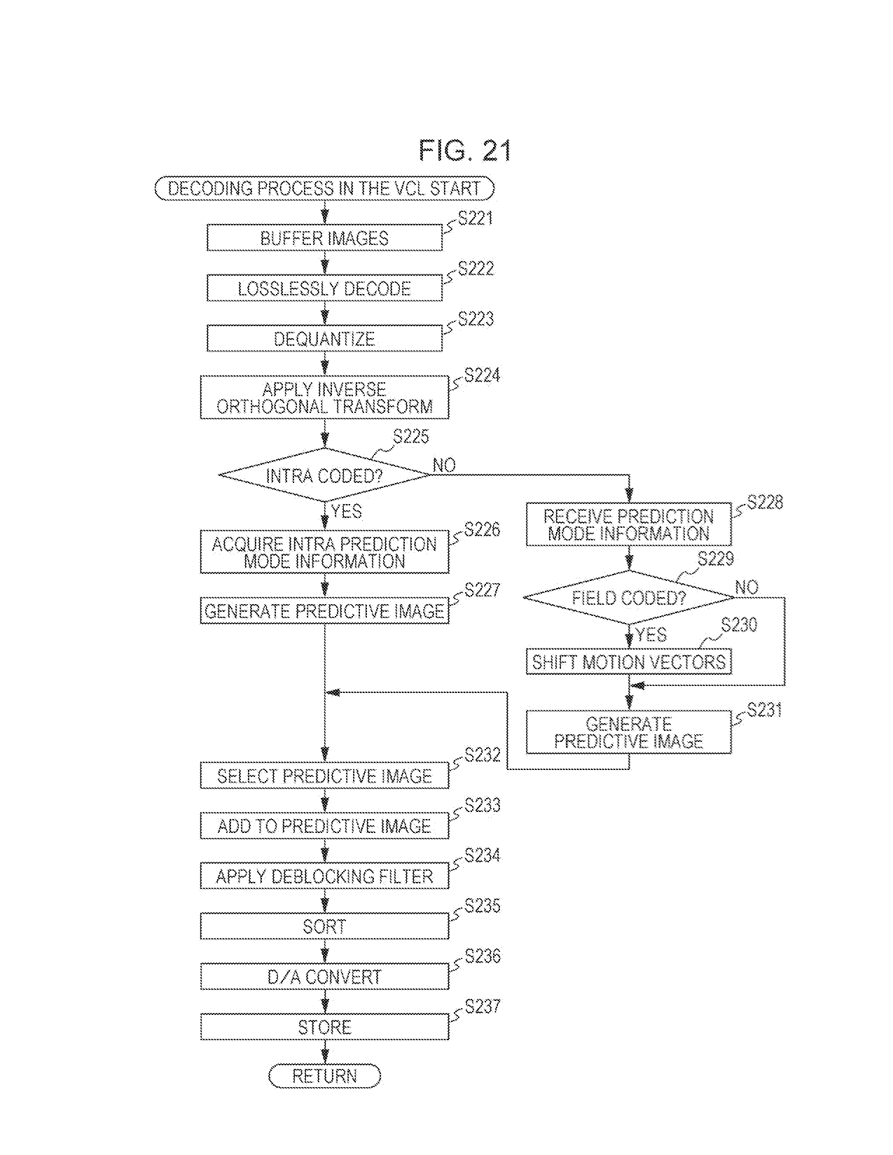

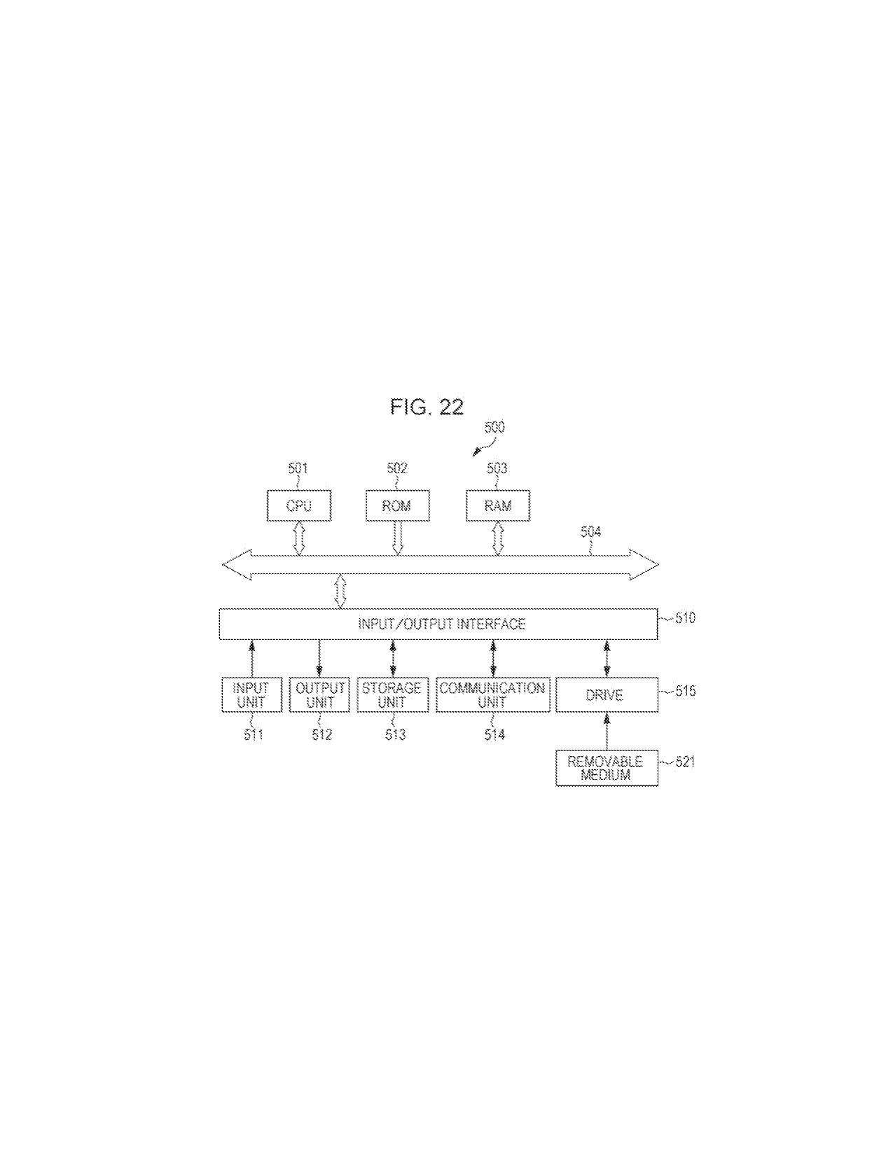

In step S204, the respective units of the image decoding apparatus 200 conduct a decoding process in the VCL. This decoding process in the VCL will be discussed later with reference to FIG. 21, but as a result of the decoding process in the VCL in step S204, the stream under the slice headers is decoded.

In step S205, the syntax receiver 251 determines whether or not the sequence has finished. If it is determined in step S205 that the sequence has not finished, the process returns to step S202, and the processing thereafter is repeated.

If it is determined in step S205 that, the sequence has finished, the decoding process of the image decoding apparatus 200 ends.

### Flow of Decoding Process in the VCL

Next, the decoding process in the VCL in step S204 of FIG. 20 will be described with reference to the flowchart in FIG. 21.

When the decoding process in the VCL starts, in step S221 the accumulation buffer 201 receives and buffers an encoded stream transmitted thereto. In step S222, the lossless decoder 202 decodes the encoded stream (i.e., encoded differential image information) supplied from the accumulation buffer 201. In other words, I pictures, P pictures, and B pictures that have been encoded by the lossless encoder 106 in FIG. 1 are decoded.

At this point, various information other than the differential image information included in the encoded stream, such as header information, is also decoded. The lossless decoder 202 may acquire prediction mode information and motion vector information, for example. The lossless decoder 202 supplies the acquired information to corresponding units.

In step S223, the dequantizer 203 dequantizes the quantized orthogonal transform coefficients obtained by the processing in step S202. Note that quantization parameters used for this dequantization processing are obtained by processing in a step S228 to be discussed later. In step S224, the inverse orthogonal transform unit 204 inverse orthogonally transforms the orthogonal transform coefficients dequantized in step S223.

In step S225, the lossless decoder 202 determines whether or not the encoded data being processed is intra coded, on the basis of information related to the optimal prediction mode that, was decoded in step S222. The process proceeds to step S226 in the case where it is determined that the encoded data being processed is intra coded.

In step S226, the intra prediction unit 211 acquires intra prediction mode information. In step S227, the intra prediction unit 211 intra predicts using the intra prediction mode information acquired in step S226, and generates a predictive image.

Meanwhile, the process proceeds to step S228 in the case where it is determined in step S226 that the encoded, data being processed is not intra coded, or in other words, is inter coded.

In step S228, the motion prediction/compensation unit 212 acquires inter prediction mode information. At this point, motion vector information is also acquired.

In step S229, the parity buffer 262 determines whether or not the current sequence is field coded, on the basis of the field coding information from, the field decoding buffer 261. The process proceeds to step S230 in the case where it is determined in step S229 that the current sequence is field coded. At this point, for each field, the parity buffer 262 supplies the motion vector shifter 222 with the per-field parity flags from the syntax receiver 251 as parity information.

In step S230, the motion vector shifter 222 shifts chroma signal motion vectors. In other words, the luma signal motion vector information from the motion prediction/compensation unit 212 is scaled to generate chroma signal motion vectors. Then, the chroma signal motion vectors are shifted by the processing in step S230, such that the vertical components of the chroma signal motion vectors are shifted on the basis of the per-field parity information as discussed, earlier with reference to FIG. 10. The motion vector shifter 222 supplies the shifted chroma signal motion vector information to the motion prediction/compensation unit 212.

Step S230 is skipped and the process proceeds to step S231 in the case where it is determined in step S229 that the current sequence is frame coded. In other words, in this case, the chroma signal motion vectors generated by scaling the luma signal motion vectors are used in the next step S231.

In step S231, the motion prediction/compensation unit 212 uses the luma signal and chroma signal motion vectors to generate a predictive image. The predictive image thus generated is supplied to the selector 213.

In step S232, the selector 213 selects the predictive image generated in step S227 or step S231. In step S233, the arithmetic unit 205 adds the predictive image selected in step S232 to the differential image information obtained by inverse orthogonal transform in step S224. In so doing, an original image is decoded. In other words, an original image is decoded by using motion vectors to generate a predictive image, and adding the predictive image thus generated to differential image information from the inverse orthogonal transform unit 204.

In step S234, the deblocking filter 206 applies deblocking filtering as appropriate to the decoded image obtained in step S233.

In step S235, the frame sort buffer 207 sorts the image filtered in step S234. In other words, the frame sequence that was sorted into an encoding order by the frame sort buffer 102 of the image encoding apparatus 100 is resorted into the original display order.

In step S236, the D/A converter 208 D/A converts the image resorted into the frame sequence in step S235. The image is output to a display not illustrated in the drawings, and the image is displayed.

In step S237, the frame memory 209 stores the image D/A converted in step S236.

Once the processing in step S237 is finished, the decoding process ends.

By conducting processes as above, the image decoding apparatus 200 is able to correctly decode encoded data that has been encoded by the image encoding apparatus 100, and improvement in the coding efficiency can be realized.

In other words, in the image decoding apparatus 200, a flag indicating field coding or not is acquired from the sequence parameter set of the encoded stream, and the encoded stream is decoded on the basis thereof.

In the case where field coding is determined, a flag indicating parity information is additionally acquired, from the APS of the encoded stream, and processing such as motion vector shifting, for example, is conducted on the basis thereof.

In so doing, an decoding process can be efficiently conducted without additional complexity in the case where the input is an interlaced signal.

Also, since the flag indicating parity information transmitted by being inserted into the APS, it becomes possible to reduce the syntax redundancies that exist in the case of the AVC format, and efficiently encode or decode interlaced signals.

Note that although the foregoing describes motion vector shifting as an example of a process that uses parity information in the case of field coding, motion vector shifting is merely an example. In other words, the present technology is also applicable to other processes insofar as they are processes that use parity information in the case of field coding.

Furthermore, although the foregoing describes a case conforming to HEVC as an example, the applicability of the present technology is not limited to examples conforming to HEVC only. The present technology is also applicable to apparatus that utilize other coding formats, insofar as they are apparatus that encode and decode with interlaced signals as input.

Furthermore, the present technology may be applied to image encoding apparatus and image decoding apparatus utilized in the case of receiving image information (bit streams) compressed, with the discrete cosine transform or another orthogonal transform, and motion compensation, as in MPEG and H.26x, for example. Such image information may be received via a networked medium such as satellite broadcasting, cable television, the Internet, or a mobile phone. Additionally, the present technology may be applied to image encoding apparatus and image decoding apparatus utilized when processing information on a storage medium such as an optical disc, magnetic disk, or flash memory. Moreover, the present technology may also be applied to a motion prediction/compensation apparatus included in such image encoding apparatus and image decoding apparatus.

### 3. Third Embodiment

### Computer

The foregoing series of operations may be executed, in hardware, and may also be executed in software. In the case of executing the series of operations in software, a program constituting such software may be installed onto a computer. Herein, the term computer includes computers built into special-purpose hardware, as well as computers able to execute various functions by installing various programs thereon, such as general-purpose personal computers, for example.

FIG. 22 is a block diagram illustrating an exemplary hardware configuration of a computer that executes the foregoing series of operations according to a program.

In the computer 500, a central processing unit (CPU) 501, read-only memory (ROM) 502, and random access memory (RAM) 503 are connected to each other by a bus 504.

Also connected to the bus 504 is an input/output interface 510. Connected to the input/output interface 510 are an input unit 511, an output unit 512, a storage unit 513, a communication unit 514, and a drive 515.

The input unit 511 may include a keyboard, mouse, and microphone. The output unit 512 may include a display and speakers. The storage unit 513 may include a hard disk and non-volatile memory. The communication unit 514 may include a network interface. The drive 515 drives a removable medium 521 such as a magnetic disk, an optical disc, a magneto-optical disc, or semiconductor memory.

In a computer configured as above, the foregoing series of operations are conducted due to the CPU 501 loading a program stored in the storage unit 513 into the RAM 503 via the input/output interface 510 and the bus 504, and executing the program, for example.

A program executed by the computer 500 (CPU 501) may be provided by being recorded onto a removable medium 521 as an instance of packaged media, for example. In addition, the program may be provided via a wired or wireless transmission medium such as a local area network, the Internet, or digital satellite broadcasting.

In the computer, a program may be installed onto the storage unit 513 via the input/output interface 510 by loading a removable medium 521 into the drive 515. The program may also be received by the communication unit 514 via a wired or wireless transmission medium, and installed onto the storage 513. Otherwise, a program may be preinstalled in the ROM 502 or the storage unit 513.

Note that a program executed by a computer may be a program in which operations are conducted in a time series following the order described in this specification, but may also be a program in which operations are conducted in parallel or at desired timings, such as upon being called.

Furthermore, in this specification, the steps describing a program recorded to a recording medium, obviously encompass processing operations conducted, in a time series following the stated order, but also encompass operations executed in parallel or individually without strictly being processed in a time series.

Also, in this specification, the term “system” represents the totality of an apparatus that includes a plurality of devices (sub-apparatus).

In addition, a configuration described in the foregoing as a single apparatus (or processor) may be divided and configured as multiple apparatus (or processors). Conversely, a configuration described in the foregoing as multiple apparatus (or processors) may be united and configured as a single apparatus (or processor). Of course it is also possible to add elements or components other than those described in the foregoing to the configuration of each apparatus (or processor). Furthermore, part of the configuration of a particular apparatus (or processor) may also be incorporated into the configuration of another apparatus (or another processor) insofar as the configuration and operation of the system as a whole is substantially the same. In other words, the present technology is not limited to the foregoing embodiments, and various modifications are possible within a scope that does not depart from the principal matter of the present technology.

An image encoding apparatus and image decoding apparatus according to the foregoing embodiments is applicable to a variety of electronic equipment, such as transmitters and receivers used to deliver content to client devices via satellite broadcasting, wired broadcasting such as cable TV, delivery over the Internet, or over a cellular network, recording apparatus that record image to media such, as optical discs, magnetic disks, and flash memory, or playback apparatus that play back images from such storage media. Hereinafter, four exemplary applications will be described.

### 4. Exemplary Applications

### First Exemplary Application: Television

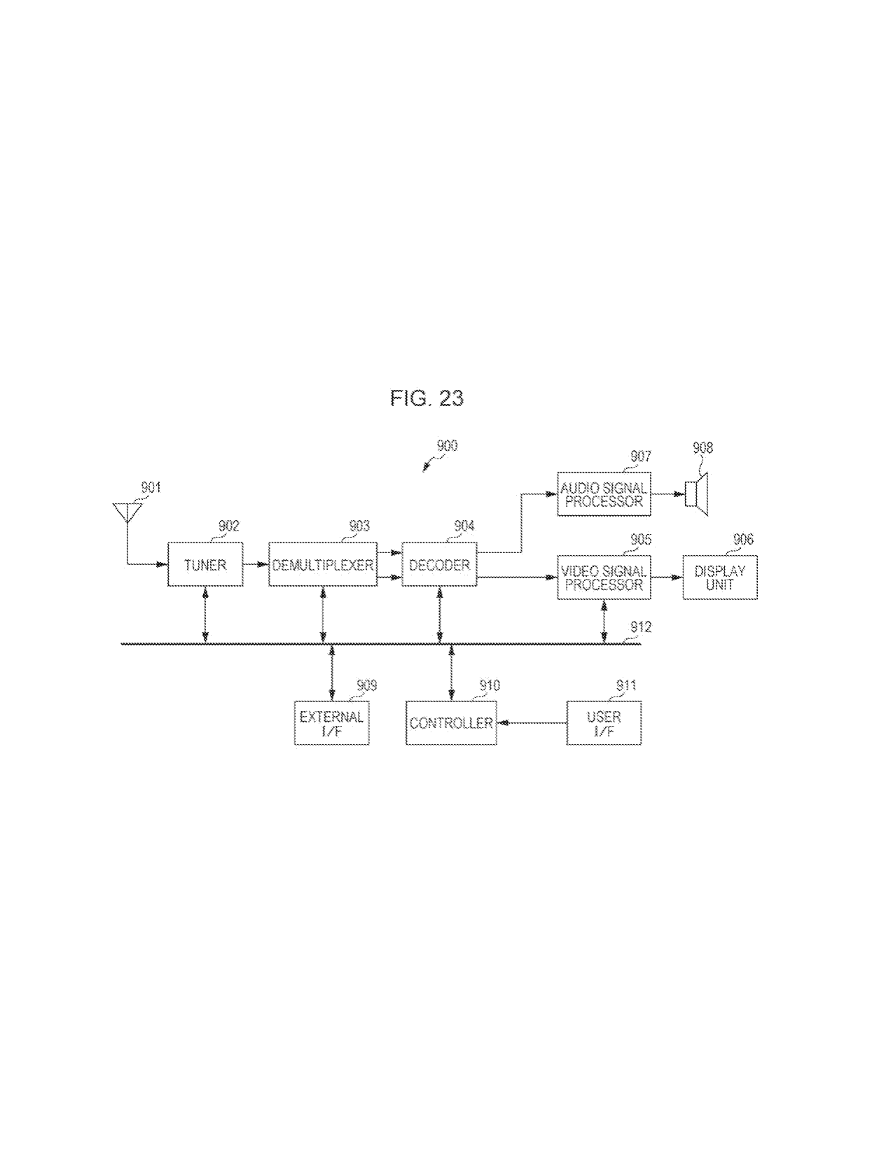

FIG. 23 illustrates an exemplary schematic configuration of a television to which the foregoing embodiments have been applied. The television 900 is equipped with an antenna 901, a tuner 902, a demultiplexer 903, a decoder 904, a video signal processor 905, a display unit 906, an audio signal processor 907, one or more speakers 908, an external interface 909, a controller 910, a user interface 911, and a bus 912.

The tuner 902 extracts the signal for a desired channel from a broadcast signal received via the antenna 901, and demodulates the extracted signal. The tuner 902 then outputs an encoded bit stream obtained, by demodulation to the demultiplexer 903. In other words, the tuner 902 fulfills the role of a communicating means in the television 900 that receives an encoded stream in which images are encoded.

The demultiplexer 903 separates the video stream and audio stream, for the program to be viewed from the encoded bit stream, and outputs the separated, streams to the decoder 904. The demultiplexer 903 also extracts supplementary data such as an electronic program guide (EPG) from the encoded bit stream, and supplies the extracted, data to the controller 910. Note that the demultiplexer 903 may also perform, descrambling in the case where the encoded bit stream is scrambled.

The decoder 904 decodes the video stream and audio stream input from the demultiplexer 903. The decoder 904 then outputs the video data generated by the decoding processing to the video signal processor 905. Additionally, the decoder 904 outputs the audio data generated by the decoding processing to the audio signal processor 907.

The video signal processor 905 plays back the video data input from the decoder 904, causing the display unit 906 to display a picture. The video signal processor 905 may also cause the display unit 906 to display application screens supplied via a network. Also, depending on the settings, the video signal processor 905 may also subject the video data to additional processing such as noise removal, for example. Furthermore, the video signal processor 905 may also generate graphical user interface (GUI) images such as menus, buttons, or a cursor, for example, and overlay the generated images onto the output image.

The display unit 906 is driven by a driving signal supplied from the video signal processor 905, and displays video or images on the screen of a display device (such as a liquid crystal display, a plasma display, or an organic electroluminescent display (OELD)).

The audio signal processor 907 subjects audio data input from the decoder 904 to playback processing such as D/A conversion and amplification, and causes audio to be output from the one or more speakers 908. The audio signal processor 907 may also subject the audio data to additional processing such as noise removal.

The external interface 909 is an interface for connecting the television 900 to external equipment or a network. For example, video streams and audio streams received via the external interface 909 may also be decoded by the decoder 904. In other words, the external interface 909 also fulfills the role of a communicating means in the television 900 that receives an encoded stream in which images are encoded.

The controller 910 includes a processor such as a CPU, as well as memory such as RAM and ROM. The memory stores information such as programs executed by the CPU, program data, EPG data, and data acquired via the network. Programs stored by the memory are read out and executed by the CPU when the television 900 is activated, for example. By executing such programs, the CPU controls the operation of the television 900 according to operation signals input from the user interface 911, for example.

The user interface 911 is connected to the controller 910. The user interface 911 may include buttons and switches by which the user operates the television 900, as well as a remote control signal receiver, for example. The user interface 911 detects operations made by the user via these components, generates an operation signal, and outputs the generated operation signal to the controller 910.

The bus 912 connects the tuner 902, the demultiplexer 903, the decoder 904, the video signal processor 905, the audio signal processor 907, the external interface 909, and the controller 910 to each other.

In a television 900 configured in this way, the decoder 904 includes the functions of an image decoding apparatus according to the foregoing embodiments. Thus, when decoding images in the television 900, decoding can be efficiently conducted in the case where the input is an interlaced signal.

### Second Exemplary Application: Mobile Phone

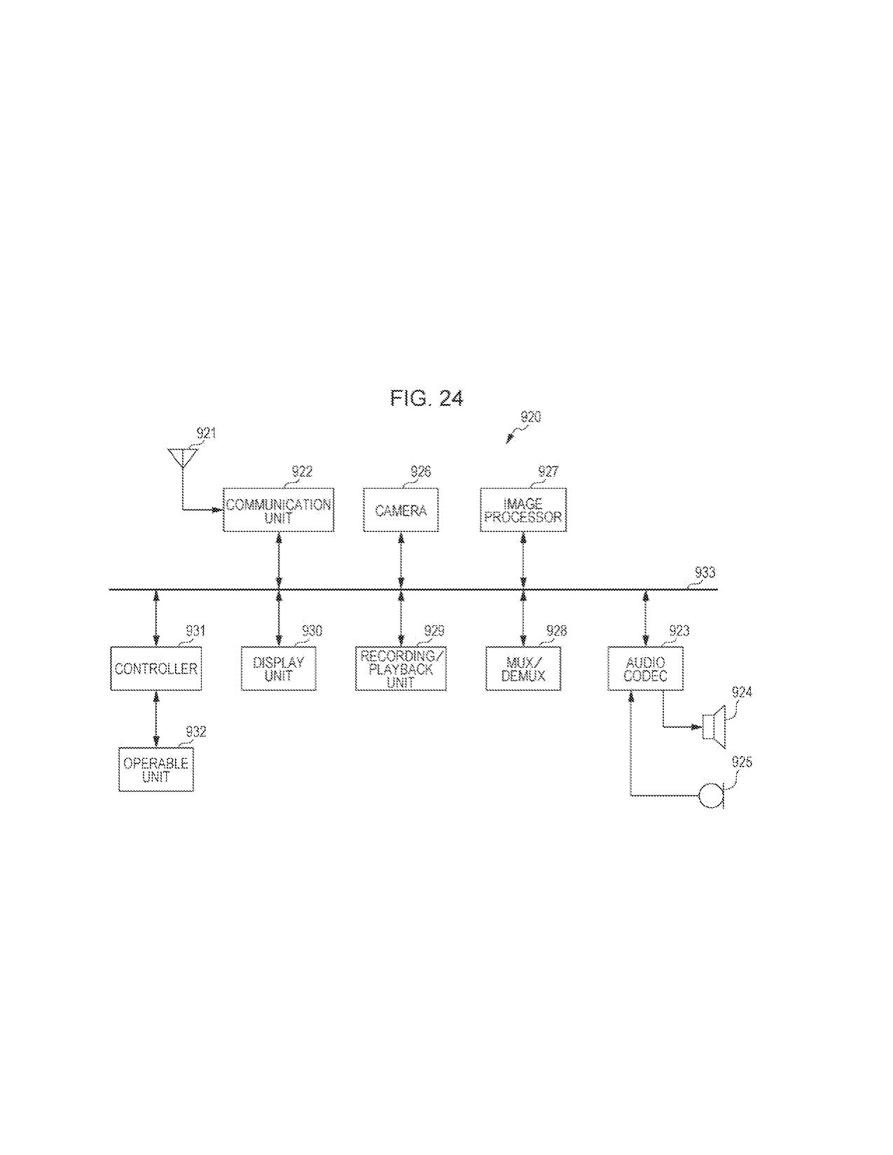

FIG. 24 illustrates an exemplary schematic configuration of a mobile phone to which the foregoing embodiments have been applied. The mobile phone 920 is equipped with an antenna 921, a communication unit 922, an audio codec 923, a speaker 924, a microphone 925, a camera 926, an image processor 927, a mux/demux 928, a recording/playback unit 929, a display unit 930, a controller 931, an operable unit 932, and a bus 933.

The antenna 921 is connected to the communication unit 922. The speaker 924 and the microphone 925 are connected to the audio codec 923. The operable unit 932 is connected to the controller 931. The bus 933 connects the communication unit 922, the audio codec 923, the camera 926, the image processor 927, the mux/demux 928, the recording/playback unit 929, the display unit 930 and the controller 931 to each, other.

The mobile phone 920 has various operational modes, including an audio telephony mode, a data communication mode, an imaging mode, and a video telephony mode. In these modes, the mobile phone 920 conducts operations such as transmitting and receiving audio signals, transmitting and receiving email or image data, taking images with a camera, and recording data.

In the audio telephony mode, an analog audio signal generated by the microphone 925 is supplied to the audio codec 923. The audio codec 923 converts the analog audio signal into audio data, and subjects the converted audio data to A/D conversion and compression. The audio codec 923 then outputs the compressed audio data to the communication unit 922. The communication unit 922 encodes and modulates the audio data to generate a transmit signal. Then, the communication unit 922 transmits the generated transmit signal to a base station (not illustrated) via the antenna 921. In addition, the communication unit 922 amplifies and frequency converts a radio signal received via the antenna 921 to acquire a receive signal. The communication unit 922 then demodulates and decodes the receive signal to generate audio data, and outputs the generated audio data to the audio codec 923. The audio codec 923 decompresses and D/A converts the audio data to generate an analog audio signal. The audio codec 923 then supplies the generated audio signal to the speaker 924 for output as audio.

Meanwhile, in the data communication mode, the controller 931 may, for example, generate text data constituting an email message according to operations performed by the user via the operable unit 932. The controller 931 causes text to be displayed on the display unit 930. The controller 931 generates email data according to transmit instructions issued by the user via the operable unit 932, and outputs the generated email data to the communication unit 922. The communication unit 922 encodes and modulates the email data to generate a transmit signal. Then, the communication unit 922 transmits the generated transmit signal to a base station (not illustrated) via the antenna 921. In addition, the communication unit 922 amplifies and frequency converts a radio signal received via the antenna 921 to acquire a receive signal. The communication unit 922 then demodulates and decodes the receive signal to restore email data, and outputs the restored email data to the controller 931. The controller 931 causes the content of the email to be displayed by the display unit 930, while also causing the email data to be stored in a storage medium of the recording/playback unit 929.

The recording/playback unit 929 includes an arbitrary readable and writable storage medium. For example, the storage medium may be an internal storage medium, such as RAM or flash memory, or an externally inserted storage medium such as a hard disk, a magnetic disk, a magneto-optical disc, an optical disc, Universal Serial Bus (USB) memory, or a memory card.

Meanwhile, in the imaging mode, the camera 926 may, for example, take an image of a subject, and generate image data, and output the generated image data to the image processor 927. The image processor 927 encodes the image data input from the camera 926, and causes an encoded stream to be stored in a storage medium of the recording/playback unit 929.

Meanwhile, in the video telephony mode, the mux/demux 928 may, for example, multiplex a video stream encoded, by the image processor 927 with an audio stream, input from the audio codec 923, and output the multiplexed stream to the communication unit 922. The communication unit 922 encodes and modulates the stream to generate a transmit signal. Then, the communication unit 922 transmits the generated transmit signal to a base station (not illustrated) via the antenna 921. In addition, the communication unit 922 amplifies and frequency converts a radio signal received via the antenna 921 to acquire a receive signal. Encoded bit streams may be included in these transmit signals and receive signals. The communication unit 922 then demodulates and decodes the receive signal to restore the stream, and outputs the restored stream to the mux/demux 928, The mux/demux 928 separates (demultiplexes) a video stream and an audio stream from the input stream, outputting the video stream to the image processor 927 and the audio stream to the audio codec 923. The image processor 927 decodes the video stream to generate video data. The video data is supplied to the display unit 930, and a series of images is displayed by the display unit 930. The audio codec 923 decompresses and D/A converts the audio stream to generate an analog audio signal. The audio codec 923 then supplies the generated audio signal to the speaker 924 for output as audio.

In a mobile phone 920 configured, in this way, the image processor 927 includes the functions of an image encoding apparatus and an image decoding apparatus according to the foregoing embodiments. Thus, when encoding and decoding images in the mobile phone 920, encoding or decoding can be efficiently conducted in the case where the input is an interlaced signal.

### Third Exemplary Application: Recording and Playback Apparatus

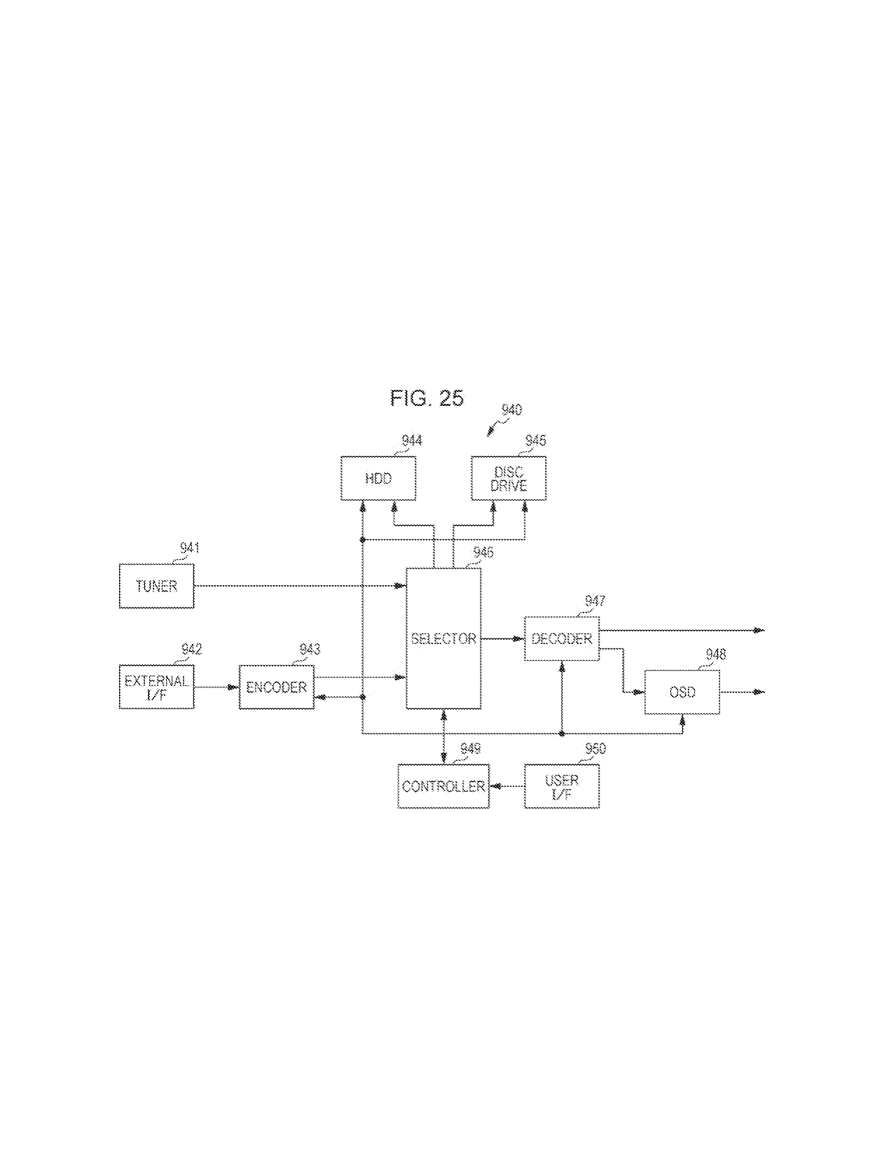

FIG. 25 illustrates an exemplary schematic configuration of a recording and playback apparatus to which the foregoing embodiments have been applied. The recording and playback apparatus 940 may encode audio data and video data from a received broadcast program, and record the encoded data to a recording medium, for example. The recording and playback apparatus 940 may also encode audio data and video data acquired from another apparatus, and record the encoded data to a recording medium, for example. The recording and playback apparatus 940 may also play back data recorded to a recording medium via a monitor and one or more speakers according to user instructions, for example. At this point, the recording and playback apparatus 940 decodes audio data and video data.

The recording and playback apparatus 940 is equipped with a tuner 941, an external interface 942, an encoder 943, a hard disk drive (HDD) 944, a disc drive 945, a selector 946, a decoder 947, an on-screen display (OSD) 948, a controller 949, and a user interface 950.

The tuner 941 extracts the signal for a desired channel from a broadcast signal received via an antenna (not illustrated), and demodulates the extracted signal. The tuner 941 then outputs an encoded bit stream obtained by demodulation to the selector 946. In other words, the tuner 941 fulfills the role of a communicating means in the recording and playback apparatus 940.

The external interface 942 is an interface for connecting the recording and playback, apparatus 940 to external equipment or a network. The external interface 942 may be an IEEE 1394 interface, a network interface, a USB interface, or a flash memory interface, for example. For example, video data and audio data received via the external interface 942 may be input into the encoder 943. In other words, the external interface 942 fulfills the role of a communicating means in the recording and playback apparatus 940.

The encoder 943 encodes video data and audio data in the case where the video data and audio data input from the external interface 942 is not encoded. The encoder 943 then outputs an encoded bit stream to the selector 946.

The HDD 944 records encoded bit streams in which video and audio or other content data is compressed, various programs, and other data to an internal hard disk. The HDD 944 also reads out such data from the hard disk during video and audio playback.

The disc drive 945 records to and reads out data from an inserted recording medium. The recording medium inserted into the disc drive 945 may be a DVD disc (such as DVD-Video, DVD-RAM, DVD-R, DVD-RW, DVD+R, or DVD+RW), or a Blu-ray Disc (registered trademark), for example.

During video and audio recording, the selector 946 selects an encoded, bit stream, input from the tuner 941 or the encoder 943, and outputs the encoded bit stream thus selected to the HDD 944 or the disc drive 945. Also, during video and audio playback, the selector 946 outputs an encoded bit stream input from the HDD 944 or the disc drive 945 to the decoder 947.

The decoder 947 decodes an encoded bit stream, and generates video data and audio data. The decoder 947 then outputs the generated video data to the OSD 948. In addition, the decoder 904 outputs the generated audio data to one or more external speakers.

The OSD 948 plays back video data input from the decoder 947 and displays a picture. The OSD 948 may also overlay GUI images such as menus, buttons, or a cursor onto the displayed picture.

The controller 949 includes a processor such as a CPU, as well as memory such as RAM and ROM. The memory stores information such as programs executed by the CPU and program data. Programs stored by the memory are read out and executed by the CPU when the recording and playback apparatus 940 is activated, for example. By executing such programs, the CPU controls the operation of the recording and playback apparatus 940 according to operation signals input from the user interface 950, for example.

The user interface 950 is connected to the controller 949. The user interface 950 may include buttons and switches by which the user operates the recording and playback apparatus 940, as well as a remote control signal receiver, for example. The user interface 950 detects operations made by the user via these components, generates an operation signal, and outputs the generated operation signal to the controller 949.

In a recording and playback apparatus 940 configured in this way, the encoder 943 includes the functions of an image encoding apparatus according to the foregoing embodiments. In addition, the decoder 947 includes the functions of an image decoding apparatus according to the foregoing embodiments. Thus, when encoding and decoding images in the recording and playback apparatus 940, encoding or decoding can be efficiently conducted in the case where the input is an interlaced signal.

### Fourth Exemplary Application: Imaging Apparatus

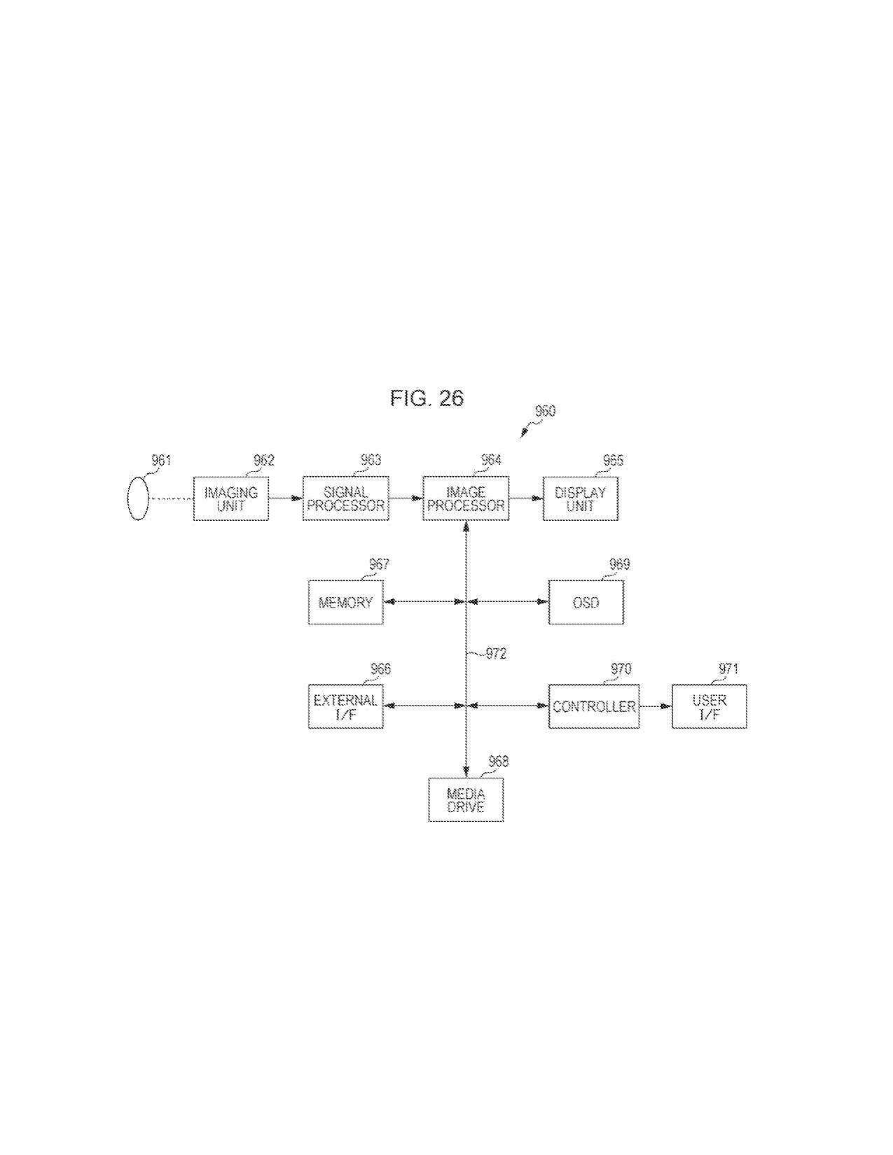

FIG. 26 illustrates an exemplary schematic configuration of an imaging apparatus to which the foregoing embodiments have been applied. The imaging apparatus 960 images a subject to generate an image, encodes image data, and records the encoded data to a recording medium.

The imaging apparatus 960 is equipped with an optical block 961, an imaging unit 962, a signal processor 963, an image processor 964, a display unit 965, an external interface 966, memory 967, a media drive 968, an OSD 969, a controller 970, a user interface 971, and a bus 972.

The optical block 961 is connected to the imaging unit 962. The imaging unit 962 is connected to the signal processor 963. The display unit 965 is connected to the image processor 964. The user interface 971 is connected to the controller 970. The bus 972 connects the image processor 964, the external interface 966, the memory 967, the media drive 968, the OSD 969, and the controller 970 to each other.

The optical block 961 includes components such as a focus lens and diaphragm mechanism. The optical block 961 forms an optical image of a subject on the imaging surface of the imaging unit 962. The imaging unit 962 includes an image sensor such as a charge-coupled, device (CCD) or complementary metal-oxide-semiconductor (CMOS), and converts an optical image formed on the imaging surface into an image signal expressed as an electrical signal by photoelectric conversion. The imaging unit 962 then outputs the image signal to the signal processor 963.

The signal processor 963 subjects the image signal input from the imaging unit 962 to various camera signal processing such as knee correction, gamma correction, and color correction. The signal processor 963 outputs the image data resulting from the camera signal processing to the image processor 964.

The image processor 964 encodes the image data input, from the signal processor 963, and generates encoded data. The image processor 964 then outputs the encoded data thus generated to the external interface 966 or the media drive 968. The image processor 964 also generates image data by decoding encoded data input from the external interface 966 or the media drive 968. The image processor 964 then outputs the generated image data to the display unit 965. The image processor 964 may also output, image data input, from the signal processor 963 to the display unit 965 and cause an image to be displayed. The image processor 964 may also overlay display data acquired from the OSD 969 onto an image output to the display unit 965.

The OSD 969 may generate GUI images such as menus, buttons, or a cursor, and output generated images to the image processor 964, for example.

The external interface 966 may include a USB input/output port, for example. The external interface 966 may connect the imaging apparatus 960 to a printer when printing images, for example. A drive may also be connected to the external interface 966 as appropriate. A removable medium such as a magnetic disk or an optical disc may be inserted into the drive, and a program read out from the removable medium may be installed onto the imaging apparatus 960, for example. Additionally, the external interface 966 may also include a network interface connected to a network such as a LAN or the internet. In other words, the external interface 966 fulfills the role of a communicating means in the imaging apparatus 960.

A recording medium inserted into the media drive 968 may be an arbitrary readable and writable removable medium such as a magnetic disk, a magneto-optical disc, an optical disc, or semiconductor memory. Also, a recording medium may be permanently installed in the media drive 968 to form a fixed storage unit such as an internal hard disk or solid-state drive (SSD), for example.

The controller 970 includes a processor such as a CPU, as well as memory such as RAM and ROM. The memory stores information such as programs executed, by the CPU and program data. Programs stored by the memory are read out and executed by the CPU when the imaging apparatus 960 is activated, for example. By executing such programs, the CPU controls the operation of the imaging apparatus 960 according to operation signals input from the user interface 971, for example.

The user interface 971 is connected to the controller 970. The user interface 971 may include buttons and switches by which the user operates the imaging apparatus 960, for example. The user interface 971 detects operations made by the user via these components, generates an operation signal, and outputs the generated operation signal to the controller 970.

In a imaging apparatus 960 configured in this way, the image processor 964 includes the functions of an image encoding apparatus and an image decoding apparatus according to the foregoing embodiments. Thus, when encoding and decoding images in the imaging apparatus 960, encoding or decoding can be efficiently conducted in the case where the input is an interlaced signal.

In this specification, an example is described in which various information such as a flag expressing field coding information, a flag expressing parity information, motion vector information, and prediction mode information is multiplexed into a an encoded stream and transmitted from encoder to decoder. However, the technique of transmitting such information is not limited to such an example. For example, such information may also be transmitted or recorded as separate data associated, with an encoded bit stream without being multiplexed into the encoded bit stream. Herein, the term “associated” means that an image included in a bit stream (also encompassing partial images such as slices or blocks) and information corresponding to that image can be linked at the time of decoding. In other words, the information may also be transmitted on a separate transmission channel from the image (or bit stream). Also, the information may be recorded to a separate recording medium, (or a separate recording area on the same recording medium) from the image (or bit stream). Furthermore, information and images (or bit streams) may be associated with each other in arbitrary units such as multiple frames, single frames, or portions within frames, for example.

The foregoing thus describes preferred embodiments of the present disclosure in detail and with reference to the attached drawings. However, the present disclosure is not limited to such examples. It is clear to persons ordinarily skilled in the technical field to which the present disclosure belongs that various modifications or alterations may occur insofar as they are within the scope of the technical ideas stated in the claims, and it is to be understood that, such modifications or alterations obviously belong to the technical scope of the present disclosure.

The present technology may also take configurations like the following.

(1) An image processing apparatus including

a receiver that, receives an encoded stream and a field coding flag indicating field coding or not and transmitted for each sequence, and

a decoder that generates an image by decoding an encoded stream received by the receiver according to the field coding flag received by the receiver.

(2) The image processing apparatus according to (1), wherein

the receiver receives a parity flag indicating the parity of individual fields and transmitted for each picture, and

in the case where the field coding flag received by the receiver indicates field coding, the decoder generates an image by decoding an encoded stream received by the receiver according to the parity flag received by the receiver.

(3) The image processing apparatus according to (2), wherein

the field coding flag is set in a sequence parameter set.

(4) The image processing apparatus according to (2) or (3), wherein

the parity flag is set in an adaptation parameter set.

(5) The image processing apparatus according to any of (1) to (4), wherein

the receiver receives instruction information for display as an interlaced signal, which is set and transmitted in a supplemental enhanced information message, and

in the case where the field coding flag received by the receiver indicates frame coding, the decoder generates an image by decoding an encoded stream received by the receiver according to the instruction information received by the receiver, and outputs the generated image as an interlaced signal.

(6) An image processing method including:

receiving an encoded stream and a field coding flag indicating field coding or not that is transmitted for each sequence, and

generating an image by decoding the received encoded stream according to the received field coding flag.

(7) An image processing apparatus including

an encoder that encodes an image according to whether or not the image is to be field coded, and generates an encoded stream,

a setting unit, that sets, for each, sequence, a field coding flag indicating whether or not to field code the image, and

a transmitter that transmits the encoded stream generated by the encoder and the field, coding flag set for each, sequence by the setting unit.

(8) The image processing apparatus according to (7), wherein

the setting unit sets, for each picture, a parity flag indicating the parity of individual fields in the case where the image is to be field coded, and

the transmitter transmits the parity flag set by the setting unit for each picture.

(9) The image processing apparatus according to (7) or (8), wherein

the setting unit sets the field coding flag in a sequence parameter set.

(10) The image processing apparatus according to (8) or (9), wherein

the setting unit sets the parity flag in an adaptation parameter set.

(11) The image processing apparatus according to any of (7) to (10), wherein

in the case where the image is to be frame coded but displayed as an interlaced signal, the setting unit sets instruction information for display as an interlaced signal in a supplemental enhanced information message, and

the transmitter transmits the supplemental enhanced information in which the instruction information has been set by the setting unit.

(12) An image processing method, including

encoding an image according to whether or not the image is to be field coded, and generating an encoded stream,

setting, for each sequence, a field coding flag indicating whether or not to field code the image, and

transmitting the generated encoded stream and the field coding flag set for each sequence.

The present disclosure contains subject matter related to that disclosed in Japanese Priority Patent Application JP 2012-008461 filed in the Japan Patent Office on Jan. 18, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a receiver that receives an encoded stream and a field coding flag indicating field coding or not that is transmitted for each sequence; and
a decoder that generates an image by decoding an encoded stream received by the receiver according to the field coding flag received by the receiver.

2. The image processing apparatus according to claim 1, wherein
the receiver receives a parity flag indicating the parity of individual fields and transmitted for each picture, and
in the case where the field, coding flag received, by the receiver indicates field coding, the decoder generates an image by decoding an encoded stream received by the receiver according to the parity flag received by the receiver.

3. The image processing apparatus according to claim 2, wherein
the field coding flag is set in a sequence parameter set.

4. The image processing apparatus according to claim 3, wherein
the parity flag is set in an adaptation parameter set.

5. The image processing apparatus according to claim 4, wherein
the receiver receives instruction information for display as an interlaced signal, which is set and transmitted in a supplemental enhanced information message, and
in the case where the field coding flag received by the receiver indicates frame coding, the decoder generates an image by decoding an encoded stream received by the receiver according to the instruction information received by the receiver, and outputs the generated image as an interlaced signal.

6. An image processing method comprising:
receiving an encoded stream and a field coding flag indicating field coding or not that is transmitted for each sequence; and
generating an image by decoding the received encoded stream according to the received field coding flag.

7. An image processing apparatus comprising:
an encoder that encodes an image according to whether or not the image is to be field coded, and generates an encoded stream;
a setting unit that sets, for each sequence, a field coding flag indicating whether or not to field code the image; and
a transmitter that transmits the encoded stream generated by the encoder and the field coding flag set for each sequence by the setting unit.

8. The image processing apparatus according to claim 7, wherein
the setting unit sets, for each picture, a parity flag indicating the parity of individual fields in the case where the image is to be field coded, and
the transmitter transmits the parity flag set by the setting unit for each picture.

9. The image processing apparatus according to claim 8, wherein
the setting unit sets the field coding flag in a sequence parameter set.

10. The image processing apparatus according to claim 9, wherein
the setting unit sets the parity flag in an adaptation parameter set.

11. The image processing apparatus according to claim 10, wherein
in the case where the image is to be frame coded but displayed as an interlaced signal, the setting unit sets instruction information for display as an interlaced signal in a supplemental enhanced information message, and
the transmitter transmits the supplemental enhanced, information in which the instruction information has been set by the setting unit.

12. An image processing method comprising:
encoding an image according to whether or not the image is to be field coded, and generating an encoded stream;
setting, for each sequence, a field coding flag indicating whether or not to field code the image; and
transmitting the generated encoded stream and the field coding flag set for each sequence.
